(19) United States
(12) Patent Application Publication
(10) Pub. No.: US 2007/0074619 A1
(43) Pub. Date: Apr. 5, 2007

(54) System and method for tailoring music to an activity based on an activity goal

(76) Inventor: Linda Vergo, Yorktown Heights, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/399,238

(22) Filed: Apr. 6, 2006

Related U.S. Application Data
(60) Provisional application No. 60/723,408, filed on Oct. 4, 2005.

(51) Int. Cl. G10H 7/00

(52) U.S. Cl. 84/612

(57) ABSTRACT

A system and method for tailoring music to an activity based on an activity goal is provided that includes: a system for defining the activity goal for the user, wherein the activity goal comprises an activity value that varies; a database of songs; a system for selecting songs from the database of songs and causing the selected songs to be played as the user performs the activity, wherein each selected song includes a tempo that guides the user to maintain an associated activity value defined in the inputted activity goal; and a feedback system that obtains feedback regarding the activity being performed by the user and determines if the user is on target to meet the inputted activity goal, wherein the feedback system automatically makes adjustments to the tempo during song playback if the user is not on target to meet the inputted activity goal.

The present invention claims priority to co-pending U.S. Provisional Application Ser. No. 60/723,408, filed on Oct. 4, 2005, entitled “ACTIVITY PROFILES FOR TAILORING MUSIC TO AN ACTIVITY.”

### BACKGROUND OF THE INVENTION

1. Technical Field

The present invention relates generally to the playback of digital music, and more specifically relates to a system and method for selecting songs during a physical activity based on a physical characteristic of a person exercising.

2. Related Art

Exercise can often be a tedious and repetitive process. One common method for making exercise more enjoyable and productive is to provide music, either via a personal audio device, such as an MP3 player, or via loud speakers. Not only is the music enjoyable, but the beat of the music provides a tempo that can guide the exercise being performed. Namely, when listening to music while exercising, it is natural and beneficial for a person to match their exercise cadence to the tempo of the music.

Anyone who has tried to create a playlist of music for the purpose of exercising knows that the process is cumbersome and error prone. Finding music that has the correct tempo, i.e., beats per minute (“BPM”), to match the physical activity being performed is tedious. For instance, a runner would ideally like to listen to a song whose tempo matches their running cadence. However, an individual (or group) that is engaged in physical activity often alters their exercise cadence, and thus requires a new song with an altered tempo to match. With today's technology, once a playlist is created, it is static. The songs have already been chosen and placed in a list. Although the playlist can be edited and/or songs can be skipped, substantial user intervention and time are required. Unfortunately, there is no easy method for matching songs with changing cadences of the person exercising.

Furthermore, many exercise routines and machines utilize programs that vary the physical activity over time or distance. For instance, a treadmill may include a program that requires the runner to change pace and/or incline each quarter mile. Since many exercise activities do not involve exercise machines, it would be advantageous to have a music playback system that could be programmed to play songs having different tempos to guide a workout routine. However, in the prior art, there exists no music playback system that can automatically select songs with varying tempos in response to a preprogrammed routine.

Moreover, when training for particular activities, the person performing the activity often tries to adhere to some target involving a parameter of the activity (e.g., speed, position, heart rate, etc.). This requires the person to monitor the parameter from time to time while engaged in the activity and make changes as necessary to stay on target. For instance, if a runner wants to run some distance in a particular target time, they may need to speed up or slow down during their run to meet their target time. In this case, it would be advantageous to have a music playback system that provided feedback by dynamically selecting and changing songs based on tempo as necessary to keep the person on target. For instance, if the runner began falling behind target split times, a song with a faster tempo could be selected to guide the runner to the necessary pace. Unfortunately, no such system exists in the prior art.

Accordingly, a need exists for a music playback system that selects songs based on the actual or required cadence of physical activities being performed.

### SUMMARY OF THE INVENTION

The present invention addresses the above-mentioned problems, as well as others, by providing a system and method for selecting songs based on an activity goal defined for the user.

In a first aspect, the invention provides a system for choosing songs for playback during an activity based on an activity goal for a user, comprising: a system for defining the activity goal for the user, wherein the activity goal comprises an activity value that varies; a database of songs; a system for selecting songs from the database of songs and causing the selected songs to be played as the user performs the activity, wherein each selected song includes a tempo that guides the user to maintain an associated activity value defined in the inputted activity goal; and a feedback system that obtains feedback regarding the activity being performed by the user and determines if the user is on target to meet the inputted activity goal, wherein the feedback system automatically makes adjustments to the tempo during song playback if the user is not on target to meet the inputted activity goal.

In a second aspect, the invention provides a method for choosing songs for playback during an activity based on an activity goal implemented for a user, comprising: defining the activity goal for the user, wherein the activity goal comprises an activity value that varies; providing access to a database of songs; selecting songs from the database of songs and causing the selected songs to be played as the user performs the activity, wherein each selected song includes a tempo that guides the user to maintain an associated activity value defined in the inputted activity goal; obtaining feedback regarding the activity being performed by the user and determining if the user is on target to meet the inputted activity goal; and automatically adjusting the tempo during song playback if the user is not on target to meet the inputted activity goal.

In a third aspect, the invention provides a computer program product stored on a computer readable medium for choosing songs for playback during an activity based on an activity goal implemented for a user, comprising: program code configured for defining the activity goal for the user, wherein the activity goal comprises an activity value that varies; program code configured for providing access to a database of songs; program code configured for selecting songs from the database of songs and causing the selected songs to be played as the user performs the activity, wherein each selected song includes a tempo that guides the user to maintain an associated activity value defined in the inputted activity goal; program code configured for obtaining feedback regarding the activity being performed by the user and determining if the user is on target to meet the inputted activity goal; and program code configured for automatically adjusting the tempo during song playback if the user is not on target to meet the inputted activity goal.

In a fourth aspect, the invention provides a method for deploying an application for choosing songs for playback during an activity based on an activity goal for a user, comprising: providing a computer infrastructure being operable to: define the activity goal for the user, wherein the activity goal comprises an activity value that varies; access a database of songs; select songs from the database of songs and cause the selected songs to be played as the user performs the activity, wherein each selected song includes a tempo that guides the user to maintain an associated activity value defined in the defined activity goal; obtain feedback regarding the activity being performed by the user and determine if the user is on target to meet the inputted activity goal; and automatically make adjustments to the tempo during song playback if the user is not on target to meet the inputted activity goal.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a computer system having a song selection system in accordance with the present invention;

FIG. 2 is a block diagram of a first embodiment of the system of the present invention;

FIG. 3 is a block diagram of a second embodiment of the system of the present invention;

FIG. 4 is a block diagram of a third embodiment of the system of the present invention;

FIG. 5 is a diagram of an Enhanced Digital Audio Music Player (DAMP)

FIG. 6 is a diagram of an Enhanced DAMP with an integrated GPS subsystem;

FIG. 7 is a diagram of an Enhanced DAMP with an integrated heart rate monitor;

FIG. 8 is a diagram of an Enhanced DAMP with an integrated cadence measurement subsystem;

FIG. 9 is a graphical representation of a beats per minute (BPM) template;

FIG. 10 is a graphical illustration of song matching to the beats per minute template;

FIG. 11 is a diagram of a BPM profile (BPMP) containing various parameters;

FIG. 12 is a flow chart showing three different methods for practicing the invention;

FIG. 13 is a flow chart showing a method for statically creating a profiled playlist based on a BPMP;

FIG. 14 is a flow chart showing a method for creating a profiled playlist based on a BPM template parameter and a music criteria parameter;

FIG. 15 is a flow chart showing a method for changing the tempo of a song via system generated tempo change request;

FIG. 16 is a flow chart showing a method for changing the tempo of a song via user tempo control;

FIG. 17 is a diagram of modules in the Run Time Control Logic;

FIG. 18 is a flow chart showing the steps of the method for dynamically selecting songs based on a BPMP parameter;

FIG. 19 is a graphical representation of a user parameter (UP) template;

FIG. 20 is a diagram of a UP profile (UPP);

FIG. 21 is a diagram showing examples of possible UP templates;

FIG. 22 is a flow chart showing the selection and execution of a speed UPP;

FIG. 23 is a flow chart showing the selection and execution of a heart rate UPP;

FIG. 24 is a diagram of a cadence matching profile;

FIG. 25 is a diagram showing the different types of activity profiles;

FIG. 26 is a diagram showing the execution of a Cadence Matching Profile (CMP);

FIG. 27 is a diagram showing a continuous BPM template without time segments;

FIG. 28 depicts a set of preprogrammed profiles; and

FIG. 29 depicts a hierarchical overview of the concepts presented in accordance with this invention.

### DETAILED DESCRIPTION OF THE INVENTION

Overview

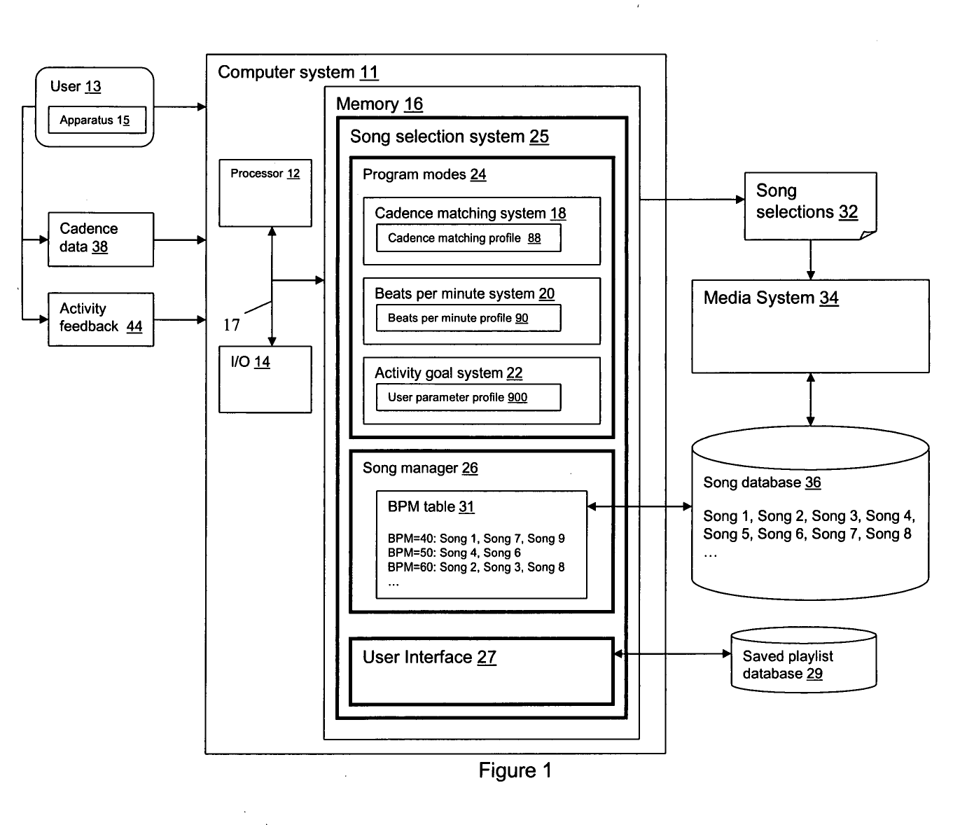

Referring now to drawings, FIG. 1 depicts a computer system 11 having a song selection system 25 that outputs song selections 32 for a media system 34 based on an actual or required tempo for a physical activity being performed by a user 13. Once selected, media system 34 can load and play songs from a song database 36 for the user 13. Media system 34 may comprise any device capable of playing songs from song database 36, e.g., media system 34 may comprise a portable device, an MP3 player, a boom box, a stereo receiver, a computer, a video player, a media player, etc. Accordingly, songs may be embodied in any format, e.g., audio, video, etc. Similarly, song database 36 may comprise any device or set of devices capable of storing digital music (or links to digital music), e.g., a hard drive, a CD, a relational database, etc.

It should be understood that all elements of FIG. 1 can be implemented within a single device or as multiple separate devices or systems or groups of systems. For instance, song database 36 may be integrated within media system 34, or may communicate remotely with media system 34 over a network, such as the Internet, cellular network, wireless network, satellite radio, etc. Similarly, song selection system 25 may be integrated within media system 34, or interface with media system 34 as an external controller, etc.

In this illustrative embodiment, song selection system 25 includes three program modes 24 including a cadence matching system 18, a beats per minute system 20, and an activity goal system 22. It is understood that this embodiment is for illustrative purposes only, as song selection system 25 may include any one or more of the three program modes 24 described herein, as well as any variations described herein, or equivalents thereof. Each of the three program modes 24 provides different methods for managing song tempos in relation to a user's activity cadence. Depending on the mode, either the song is selected in response to the cadence of the user 13, or the cadence of the user 13 is guided by the tempo of the selected song.

Song manager 26 is utilized to make song selections 32 for the program modes 24 based on tempo. For the purposes of this disclosure, tempo refers to a beat rate, or beats per minute (BPM). (Note that for the purposes of this disclosure, the term beats per minute “BPM” should be interpreted broadly to include all equivalent ways of measuring tempo, e.g., beats per second, etc.) In this illustrative embodiment, song manager 26 includes a BPM table 31 that associates songs in the song database 36 with particular BPMs. BPMs are one illustrative type of metadata that can be utilized to categorize songs to allow for selection. However, it should be understood that other types of metadata, such as genre, song length, etc., could also be utilized. In the example shown, songs 1, 7 and 9 are identified as having a BPM value of 40, songs 4 and 6 are identified as having a BPM value of 50, and songs 2, 3 and 8 are identified as having a BPM value of 60. Thus, when one of the program modes 24 requires a song at a particular BPM, the song manager 26 examines the BPM table 31 and selects one of the songs that matches the required BPM.

If more than one song is available for a required BPM, song manager 26 can utilize any algorithm and/or additional metadata (i.e., selection criteria) to select the song, e.g., randomly, in order, based on favorites, title, artist, genre, theme, user rating, category, album, bit rate, comment, composer, date added, date modified, description, disc number, episode number, equalizer, grouping, kind, last played, my rating, play count, sample rate, season, show, size, time, track number, year, etc.

It should be recognized that while this embodiment uses a BPM table 31 to implement song manager 26, any other architecture could be utilized, e.g., BPM data could be incorporated directly into song database 36. Moreover, a utility, such as a crawler could be provided to crawl through a database of songs and collect metadata information, such as BPM, genre, length, etc. The utility may provide metadata by accessing secondary databases and other network attached sources over a network.

In addition, it is noted that a given BPM value also has harmonic values, which may be used in program modes described here. For example, music that is 120 BPM has harmonics at 60 and 30 BMP. A program mode 24 that calls for a 60 BPM song could select a 120 BPM song since it has a 60 BPM harmonic. Songs with harmonics can be selected using the same tolerance level rules described below. In addition, song manager 26 may allow for some tolerance (e.g., 2-3%) between the tempo that is required by the program mode 24 and the tempo of a given song. Thus, a range of tempos may be used to match an activity cadence. For instance, if the song manager 26 needed a song with a tempo of 59 BPM, songs having a tempo from 57 to 61 BPMs may be considered a match.

The cadence matching system 18 provides a first program mode in which cadence data 38 is captured and inputted from the user performing a physical activity. For instance, for a runner the cadence may comprise a rate at which strides are made, for a cyclist the cadence may comprise a pedaling rate, for a swimmer the cadence may comprise a stroke rate, etc. Cadence data 38 may be captured from the user 13 in any manner, e.g., via a monitoring device attached to the user, a monitoring device attached to an apparatus 15 such as a bicycle, treadmill, etc. In general, cadence data 38 comprises a cadence rate, e.g., strokes/minute, strides/minute, etc. As the cadence data 38 is collected, cadence matching system 18 matches the cadence data 38 to a tempo, or BPM. Once the BMP is determined, song manager 26 can make a song selection 32 for media system 34, which loads the song from the song database 36 for playback. In this manner, a song is played having a tempo that matches the cadence of the user 13. When the user 13 changes his or her cadence, cadence matching system 18 can cause a new song to be played (e.g., using a fade out, fade in technique) or it can alter the tempo of the song being played at the time to match the user's cadence. Alternatively, the playback tempo of the song can be manually adjusted (e.g., within a tempo change tolerance level) via a user interface 27. In addition, in order to avoid overly-rapid changing of songs, cadence data 38 may be examined at spaced time intervals (e.g., every 20 seconds), the cadence data 38 may be averaged over time, etc. The various parameters of the cadence matching system 18 can be implemented within a cadence matching profile 88. Further details of such a profile are described below with an illustrative embodiment utilizing a cadence matching profile (CMP).

Beats per minute system 20 provides a second mode in which a beats per minute profile 90 is provided to guide the activity of the user 13. In this program mode, the user's activity or cadence is guided over time or distance by the different activity characteristic values (e.g., tempos, genres) provided in the beat per minute profile 90. For instance, the beats per minute profile 90 may call for a warm-up phase having a BPM of 50, then a main exercise phase of 60 BPM, and then a cool down phase of 40 BPM. Thus, for a first time period, beat per minute system 20 instructs the song manager 26 to select a song or songs having a BPM of 50, then switch to a song or songs having a BPM of 60 for a second period of time, and then switch to a song or songs having a BPM of 40 for a third period of time. The beats per minute profile 90 may be inputted in any manner, e.g., it may be programmed by the user via an interface, loaded by the user 13 from an external source, selected by the user 13 as one of a plurality of available programs stored within computer system 11, etc.

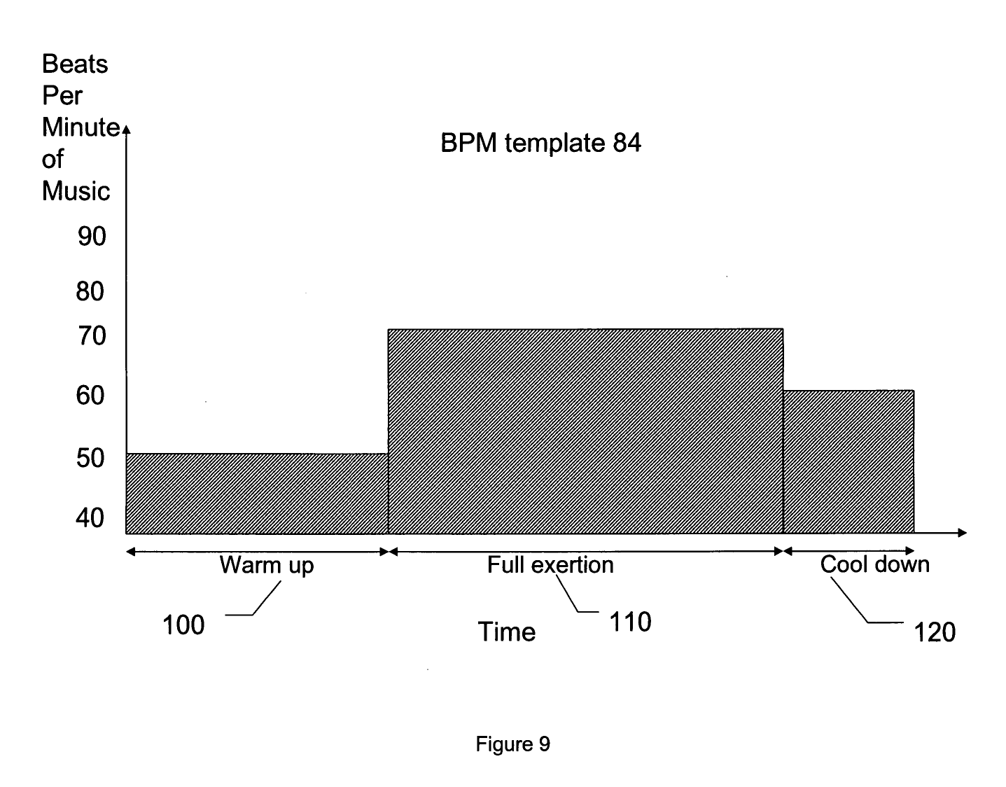

The various parameters of the beats per minute system 20 may be implemented as a BPM profile 90 that includes a BPM template 84 and various other settings and parameters (e.g., see FIGS. 9-11).

Activity goal system 22 provides a third program mode in which the user 13 can set an activity goal for a particular activity over a time or distance. The activity goal may relate to any type of parameter. For instance, the activity goal may relate to a desired time to cover a distance, a distance or position to be achieved over a particular time period, a heart rate, a breathing rate, etc. The activity goal is contained in the user parameter profile (UPP) 900 which may be provided to activity goal system 22 in any manner, e.g., selected from a set of user parameter profiles 900, inputted, programmed via user interface 27, etc. Once the activity goal is provided to activity goal system 22, a plan is assembled for achieving the activity goal. The plan includes activity values that must be met to achieve the activity goal. For instance, if a runner wanted to run 10 miles in 50 minutes, the plan might call for the first two miles to be run in eight minutes, the next six miles to be run in 30 minutes, and the last two miles to be run in 12 minutes. The assembled plan essentially comprises a beats per minute profile 90 described above. The plan may be assembled based on user input via interface 27, be selected from among a number of stored plans, be generated automatically without user intervention, etc.

Based on the assembled plan, songs are selected by activity goal system 22 to provide a tempo that will guide the cadence of the user 13 to meet the activity goal in accordance with the plan. Thus, for the runner described above, a first set of songs will be selected having a tempo to guide the user 13 to running two miles in eight minutes. Activity feedback 44 is collected at regular time intervals (or continuously) to determine if the user 13 is on target. If the user 13 is not on target (e.g., the user is falling behind the goal), then the plan may be altered to change the tempo of the current song or to select a new song with a different tempo that will put the user 13 back on target. Activity feedback 44 may be collected in any manner, e.g., via a device such as a global positioning system (GPS), via a clock, via sensors attached to the user 13, via sensors attached to an apparatus 15 such as an odometer on a bicycle, treadmill, etc.

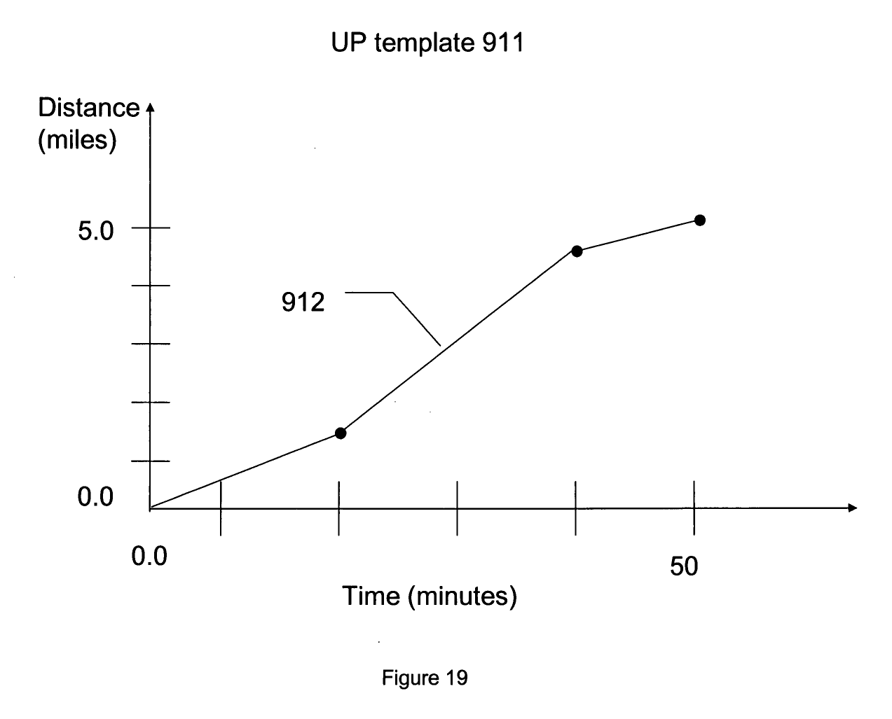

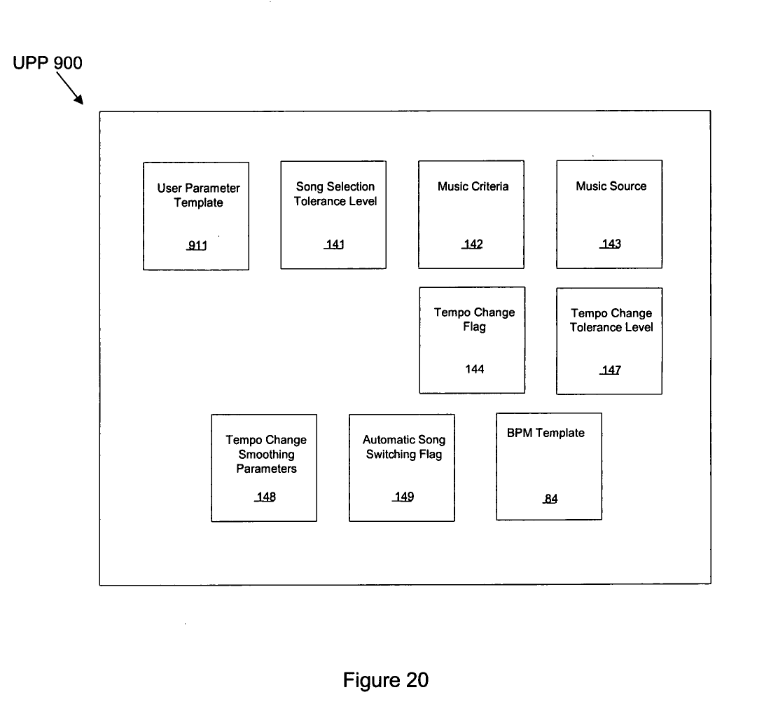

In an illustrative embodiment described below, the various parameters of the activity goal system 22 are implemented using a user parameter profile 900 (UPP) which is described in further detail below with reference to FIG. 20. As described below, the UPP 900 is comprised of a user parameter template 911 and other parameters (see FIG. 19 and related discussion).

Note that for each of the above-mentioned program modes, the user 13 can save the list of songs played during an activity to a saved playlist database 29. Thus, if a user 13 particularly enjoyed a given sequence of songs played during a workout, the user 13 can save the list and replay the songs at a later time.

In general, computer system 11 may comprise any type of computing device, and could be implemented as part of a client and/or a server. Computer system 11 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 11 and likewise may comprise any known type of transmission link, including electrical, optical, wireless, etc. Although not shown, additional components, such as cache memory, communication systems, system software, etc., may be incorporated into computer system 11.

Illustrative Embodiments

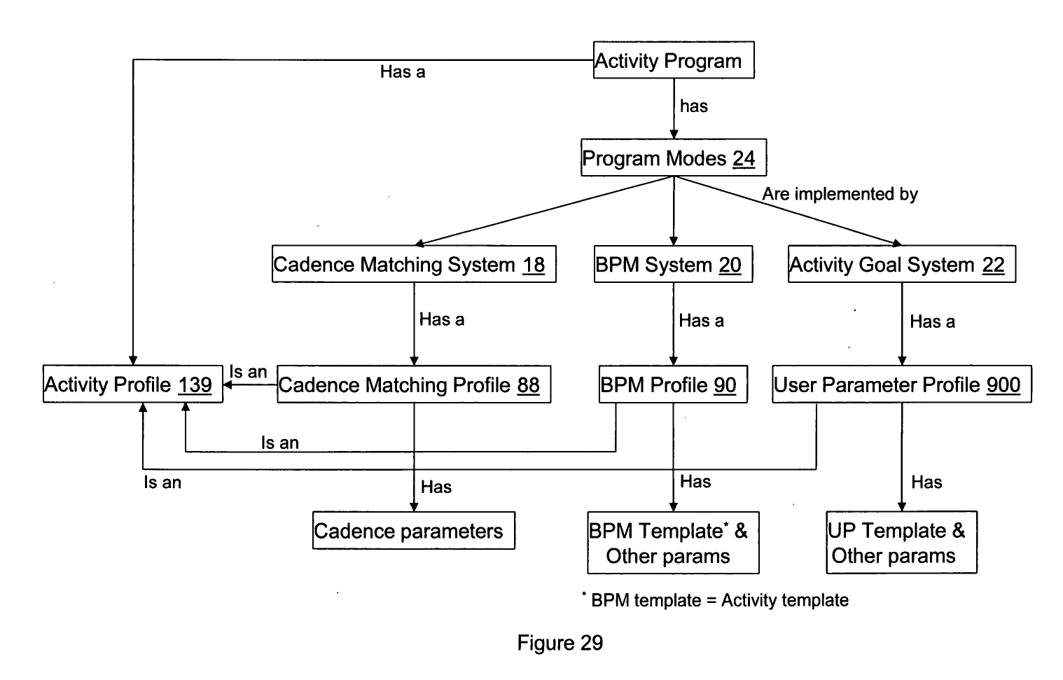

FIG. 29 shows some of the major concepts of the invention and their relationship to one another.

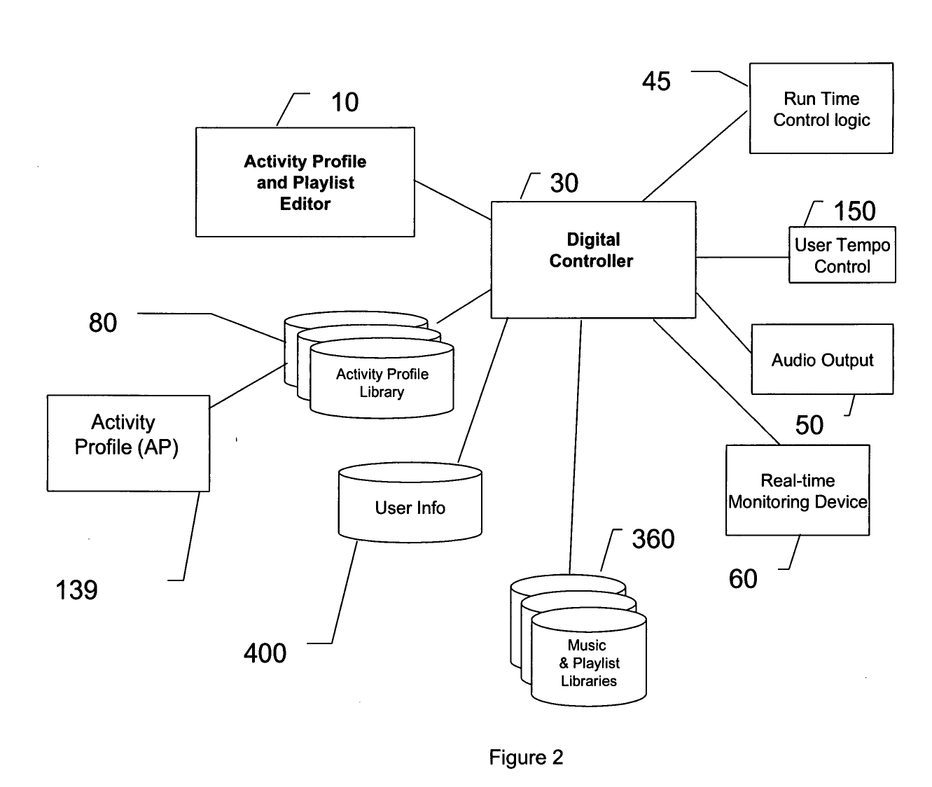

FIG. 2 shows an overview of one illustrative embodiment of the system of the present invention. The system comprises a digital controller 30 having an Activity Profile and Playlist Editor 10 (hereinafter “editor 10”) for creating and editing Activity Profiles (AP) 139 and song playlists. APs 139 are described in more detail below. The digital controller 30 comprises an Activity Profile Library 80 for storing the APs 139, and a Music and Playlist Library 360 for storing songs, Profiled Playlists, and song playlists as part of a locally maintained library. The digital controller 30 has a CPU for processing information and one or more storage devices (e.g., memory card) for storing the AP Library 80 and the Music and Playlist Library 360.

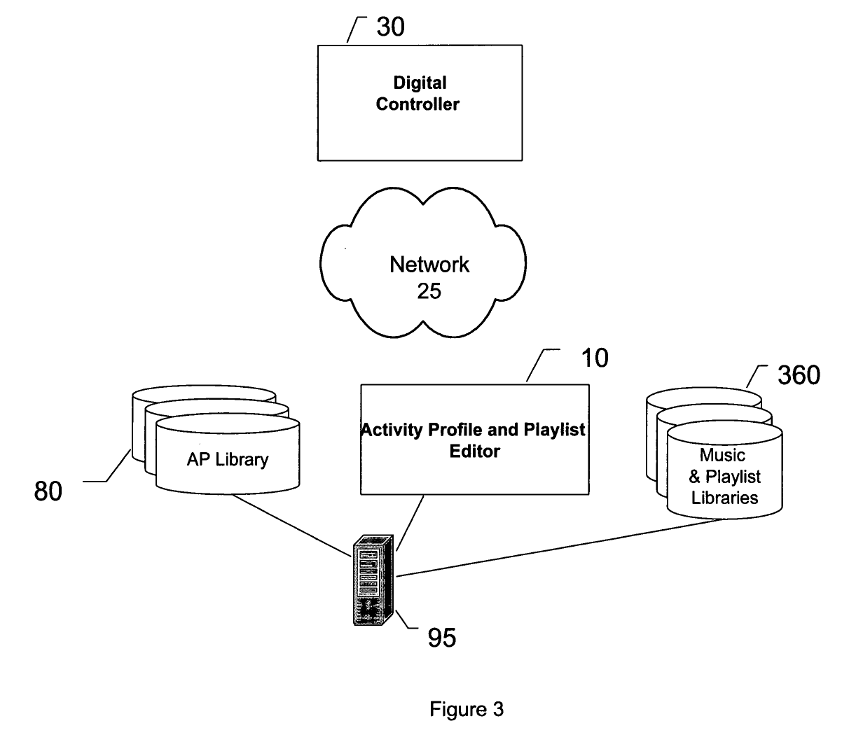

In another illustrative embodiment of the present invention, FIG. 3 shows a digital controller 30 which is remotely connected to the editor 10 and the libraries 80 and 360 via network 25 such as an intranet, Internet, or wide area network, etc. The editor 10 and libraries 80 and 360 are remotely provided on one or more personal computers or servers 95. The user remotely creates or edits an AP with the editor 10, and the AP is then transferred across the network 25 to the digital controller 30. The library 360 may be an Internet-based library that is either operated by the user on a remote personal computer or by an online music store such as Apple Corp. iTUNES®. Songs and playlists can be downloaded from the library 360 to the digital controller 30 via the network 25. Music can be selected and downloaded from more than one source simultaneously.

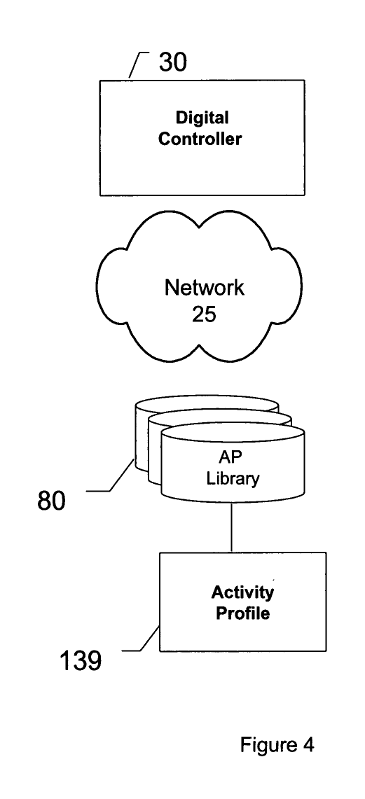

FIG. 4 shows another embodiment of the invention in which the digital controller 30 is connected to an AP 139 via a network 25 such as the Internet or intranet, facilitating uploading or downloading of APs to and from AP Internet library service 80. After creating an AP with the editor 10, a user can upload the AP to the AP Internet library service 320 for the purpose of sharing. The user can also download an AP that was created by a third party from an AP Internet library service instead of creating an AP with the editor 10. However, the editor 10 can be used to edit the downloaded AP.

In all of the embodiments shown in FIGS. 2-4, the digital controller 30 also contains user tempo control 150 so that the user may change the tempo of a song during playback, run-time control logic 45 for dynamically selecting and playing songs, an audio output 50, and one or more real-time monitoring devices 60 for providing actual measurements of user characteristics during an activity.

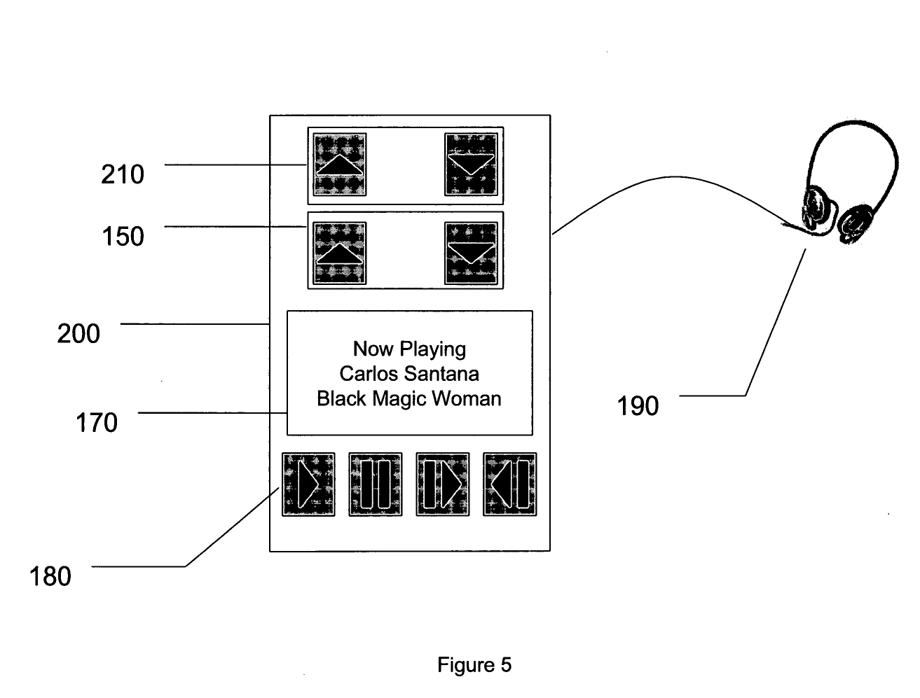

FIG. 5 shows one exemplary embodiment of the digital controller 30 in the form of an enhanced digital audio music player (“DAMP”), which includes a case 200 containing the hardware and software components, user tempo control 150 for adjusting the tempo, a display screen 170 for identifying the song that is playing and displaying additional editor 10 controls, a control panel 180 for executing playback options such as play, pause, rewind, and fast forward, a headset 190 as an example of audio output, and a set of controls 210 for controlling the volume. Examples of DAMPs include portable and non-portable mp3, CD, and DVD players.

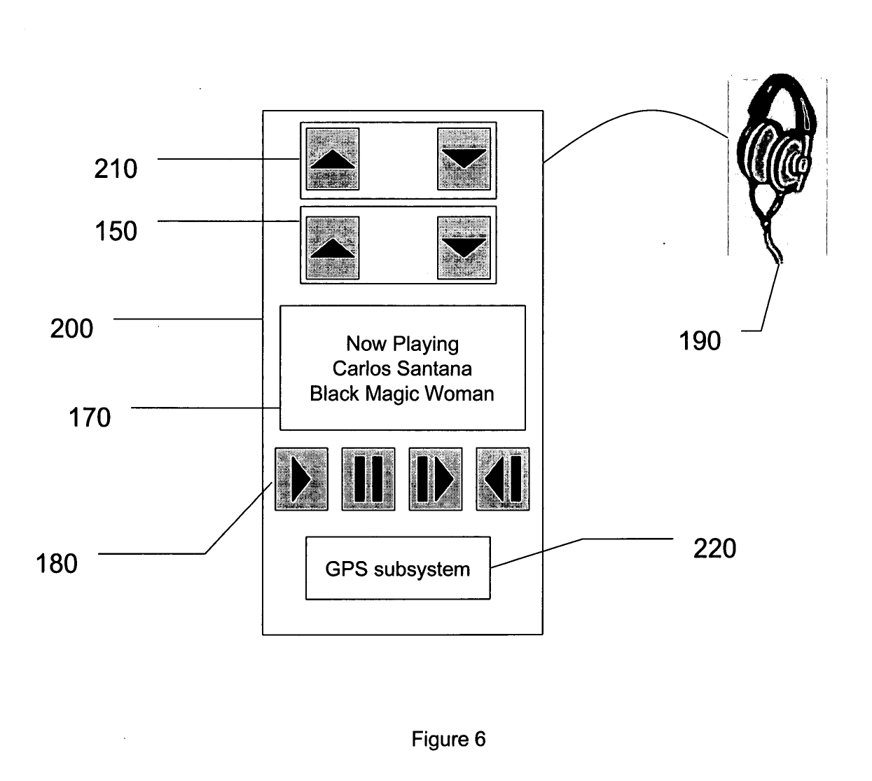

Another exemplary embodiment of the digital controller 30 in the form of an enhanced DAMP is shown in FIG. 6, wherein the DAMP further includes a GPS subsystem 220 for providing the position of the user. Thus, the GPS subsystem 220 is a specific example of a real-time monitoring device 60 of the digital controller 30.

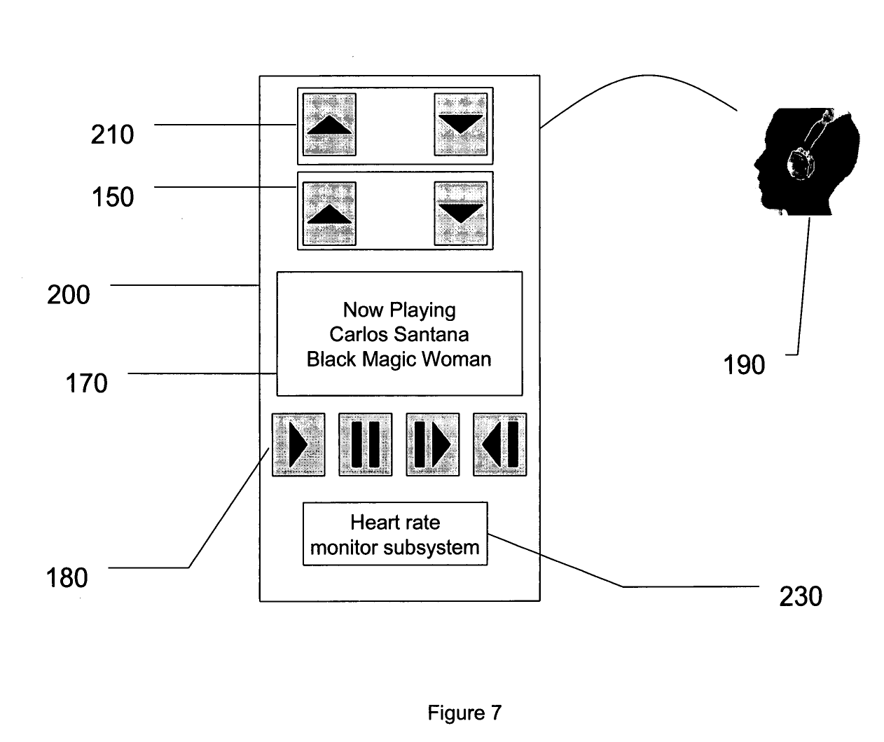

FIG. 7 shows another example of an enhanced DAMP in which a heart rate monitor subsystem 230 is a specific example of a real-time monitoring device 60 used to monitor the heart rate of the user during an activity over a period of time.

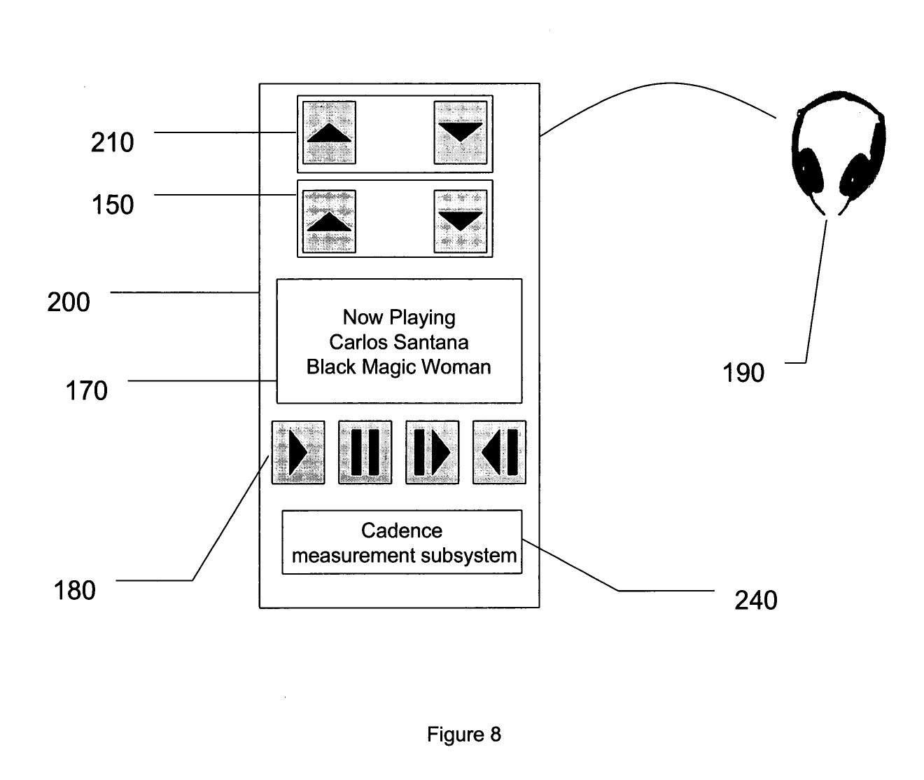

FIG. 8 shows an example of an Enhanced DAMP in which a cadence measurement subsystem 240 is a specific example of a real-time monitoring device 60. The output of the cadence measurement subsystem 240 (the cadence of the user) may be used as input to the digital controller 30 for a variety of APs.

An illustrative method for carrying out the invention first involves creating an AP 139. In the illustrative embodiments described above, the editor 10 is a software component of the digital controller 30, which a user operates to create an AP 139. However, the editor 10 may be optionally located on a personal computer so that the AP 139 can be created remotely and then transferred to the digital controller 30 for execution. The editor 10 may also be used by third parties such as a manufacturer of the digital controller 30 or Internet file sharers to create APs which can be made available for online distribution or for distribution with digital controllers to users.

In accordance with the invention, a user creates an AP that is tailored to a desired activity. The AP is then translated into a specialized playlist of music, either statically or dynamically, which the user can interact with.

In accordance with the different illustrative embodiments described herein, three types of Activity Profiles (APs) are described, including: cadence matching profiles (CMPs), beats per minute profiles (BPMPs), and user parameter profiles (UPPs). A common thread among these profiles is the use of a parameter set that dictates the operational behavior of a media player, such as a digital audio music player. It should be noted that the make-up and size of the described parameter sets can vary without departing from the scope of the invention. Each AP will be described in more detail below.

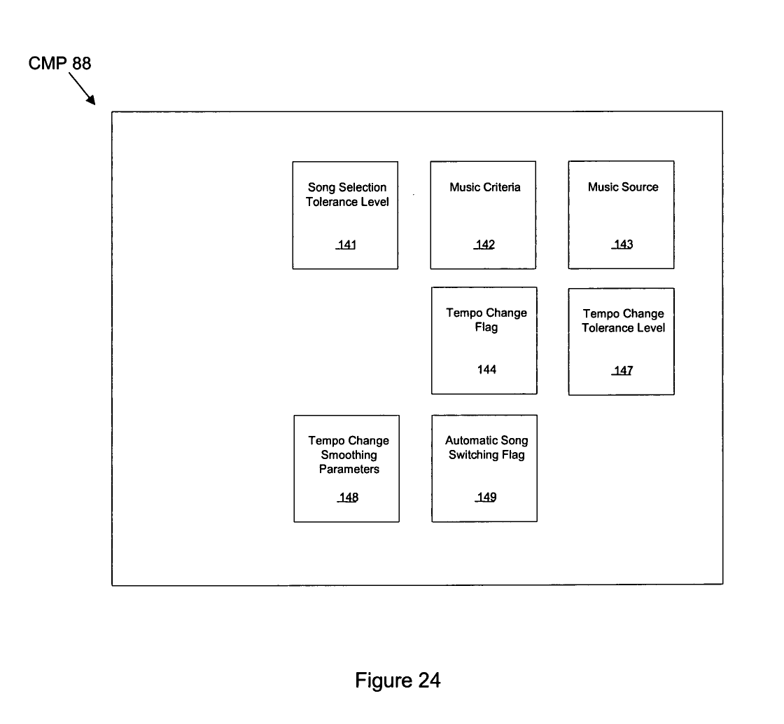

FIG. 24 shows an illustrative embodiment of a CMP 88. The CMP 88 is a profile comprised only of parameters that dictate the operational behavior of music playback in a cadence matching application, such as that described above with reference to FIG. 1. The parameters include a song selection tolerance level 141, music criteria 142, music source 143, tempo change flag 144, tempo change tolerance level 147, tempo change smoothing parameters 148, and automatic song switching flag 149.

The song selection tolerance level 141 defines a range of BPM for songs that are close enough to a specified BPM value to be sufficient as a match. The song selection tolerance level 141 may be expressed as an absolute number of BPM, or as a percentage of a BPM. The two examples below will illustrate this point:

Example 1: At a specified time, a song is needed that has a value of 80 BPM. The tolerance level is specified at 3 BPM. Therefore, songs that are in the range of 80 BPM +/−3 BPM are acceptable. That means all songs in the range of 77 to 83 BPM are within the tolerance range.

Example 2: At a specified time, a song is needed that has a value of 80 BPM. The tolerance level is specified at 10%. Therefore, songs that are in the range of 80 BPM +/−10% are acceptable. That means all songs in the range of 72 to 88 BPM are within the tolerance range.

Music criteria 142 is used for selecting songs based on attributes of the music other than the BPM. Digital music, such as songs in mp3 format, can be selected by a predetermined music criteria via metadata. Descriptive metadata typically includes identification of title, artist, date, genre, theme, etc. The metadata can also include lyrics, titles and other verbal comments. The metadata is maintained in an SQL database associated with the music library 360. If a user sets music criteria in an AP, the music criteria parameter will be used when selecting songs.

Music source 143 defines the location of a particular music library. The tempo change flag 144 parameter defines whether songs are always to be played at their original tempo or whether the tempo may be modified to match the specified BPM, and the tempo change tolerance level 147 parameter defines the extent to which the tempo of songs can be changed. The tempo change smoothing parameters 148 are used by the tempo change smoothing function to control how changes of tempo are handled, preventing wild fluctuations in changes of tempo. The automatic song switching flag 149 controls whether the playing of a song can be interrupted and replaced by a new song when a tempo change request exceeds the tempo change tolerance level 147.

These parameters, when associated with a CMP 88, will provide a basis for managing the tempo of music to make it adhere to a user activity.

The second type of activity profile, referred to herein as a beats per minute profile (BPMP), is utilized to control an application that selects music of different tempos to guide a user's activity. Such a system is described above as a BPM system 20 in FIG. 1. In the present invention, the tempo (e.g., BPM) of music and how it varies over time (or distance) is a primary feature of a BPMP. This feature is captured in a BPM template 84. FIG. 9 shows an example of a BPM template 84 which is a quantitative representation of music tempo as a function of time for an activity. In FIG. 9, the BPM template 84 is represented graphically. However, it should be noted for the purposes of this disclosure that such a template can be implemented in a variety of ways including, e.g., as mathematical functions, tables, computer programs, as a set of rules, etc. Accordingly, the term “template” should be broadly interpreted to include any method of representing tempo as a function of time or distance. For example, a mathematical function that describes the activity template in FIG. 9 may be implemented as follows:
BPM(x)=50 for 0<x<=10
BPM(x)=70 for 10<x<25
BPM(x)=60 for 25<x<30,
where x is the time and BPM(x) is the beats per minute at a given time x.

The same activity template may be described in a table as follows:

| Start time | End time | BPM |
|---|---|---|
| 0 | 10 | 50 |
| 10 | 25 | 60 |
| 25 | 30 | 55 |

and the same activity template may be described as a logical expression as follows:
If (time>0) and (time<10)

Then BPM=50
Else if (time>10) and (time<25)

Then BPM=70
Else if (time>25) and (time<30)

Then BPM=60

The beats per minute data is determined by the creator of the BPM template 84 which can be either the user, or a third party such as a manufacturer. The editor 10 allows the creator to assign the beats per minute over various time segments of the activity and create a BPM template 84. The determination and assignment of the music's beats per minute for a particular time segment may be made based on experience or may involve empirical research into different types of activities and the beats per minute that is determined to be most suitable for the activities. Such research knowledge can be presented to the user in the User profile.

A detailed example of how the beats per minute may be assigned for different time segments of an activity in a BPM template is shown in FIG. 9. The time segments divide the activity into a pattern of varying beats per minute. FIG. 9 shows a traditional exercise template having a first warm-up time segment 100, a second fill exertion time segment 110, and then a last cool-down time segment 120. The warm up time segment 100 is designated at a tempo of 50 BPM, the exertion time segment 110 at 70 BPM, and the cool down time segment 120 at 60 BPM. Although one example is shown in FIG. 9, a user can create as many time segments as desired, with any assigned BPM. A single BPM value or a range of varying BPM values can be assigned to a particular time segment.

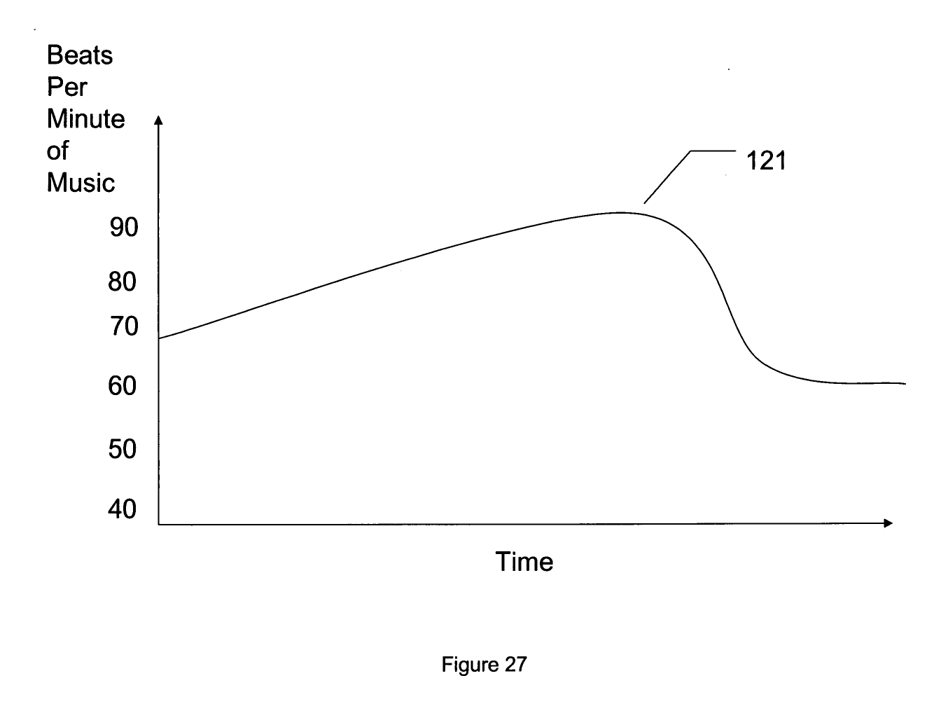

BPM templates may be designed with any combination of fixed time length segments, automatically adjustable time length segments, or time segments that are allocated percentages of the overall profile length. For example, a user may construct a template with four time segments, where the first time segment is 20% of the template's overall time length, the second time segment is 40%, the third time segment is 25%, and the fourth time segment is 15%. Alternatively, a BPM template may be defined as a continuous function of BPM over time, where no time segments are defined. FIG. 27 shows such a continuous BPM template 121. BPM templates are constructed based on a variety of factors. BPM templates may be constructed around information about a user such as age, weight, height, general state of health, etc. Standard BPM templates for different ages, gender, athletic ability, physical conditioning can be pre-packaged or otherwise sold separately.

Also, BPM templates may be constructed and changed based on research in the medical, sports medicine, and human physiology areas. For example, a user may assign 80 beats per minute to jogging or running and 50 BPM to walking because walking is much slower. However, a manufacturer or third party provider of a BPM template may assign 70 BPM to jogging or running and 45 BPM to walking based on research studies of the activities and human physiology.

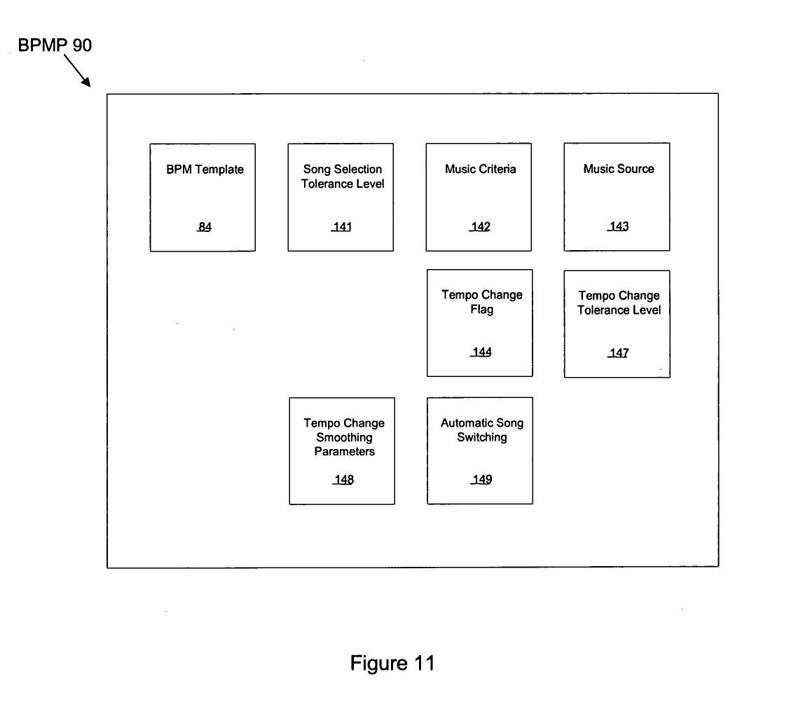

As shown in FIG. 11, the BPM template 84 is the primary characteristic of a BPMP 90 that is packaged or stored with other parameters in a single BPMP 90, which is preferably embodied as a single data file. The other parameters are the same as described in the CMP 88 section of this document. The parameters are created by the user using editor 10 or provided by a third party such as a manufacturer or retailer.

The third type of activity profile, referred to herein as a user parameter profile (UPP), is utilized to control an application that utilizes feedback to select music of different tempos to guide a user's activity. Such as system is described above as an activity goal system 22 in FIG. 1. In the present invention, a user monitored parameter, and how it varies over time, is a primary feature of a UPP. This feature is implemented as a UP Template 911.

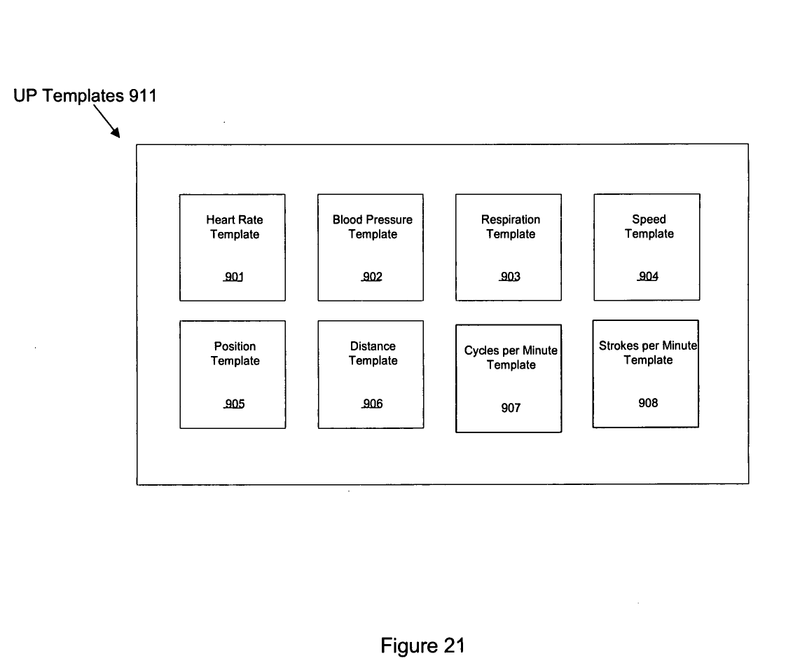

FIG. 19 shows an example of a UP template 911 wherein the user has defined the desired distance 912 to attain over the course of the activity period. Other possible types of UP templates are described in FIG. 21.

As shown in FIG. 20, the UP template 911 is the primary characteristic of a UPP 900 that is packaged or stored with other parameters in a single UPP 900, which is preferably embodied as a single data file. The other parameters are the same as described in the CMP 88 section of this document with the exception of the BPM template 84. In a UPP 900, the UP Template 911 is converted to a BPM Template 84, which is then stored as part of the UPP 900. The BPM Template determines which songs will be selected when the UPP 900 is engaged. The parameters are created by the user using editor 10 or provided by a third party such as a manufacturer or retailer.

UP templates are converted into BPM templates prior to user execution the UPP. The algorithm for performing the conversion depends on the type of UP template. We provide two examples of how such conversions are performed.

The first example is of a distance UP template. In this example, assume the template calls for a constant speed, i.e. the distance template is linear and has a constant slope. Further, assume the UP template calls for a speed of six miles per hour for the duration of the activity profile. In order to convert the UP template to a BPM template, we make the simplifying assumption that the user's stride length is constant, e.g., 3 ft. Hence the user's cadence can be calculated as follows:
(6 miles/hour)*(5280 ft/mile)*(1 step/3 ft)*(1 hour/60 minutes)=175 steps/minute

The BPM template is set to match the cadence. Thus, a distance UP template with a slope of six miles per hour results in a constant BPM template of 175 BPM. The mathematics for handling distance UP templates with a series of constant speed segments (such as illustrated in FIG. 19) or continuously changing speed templates (such as is illustrated in FIG. 27) are well understood.

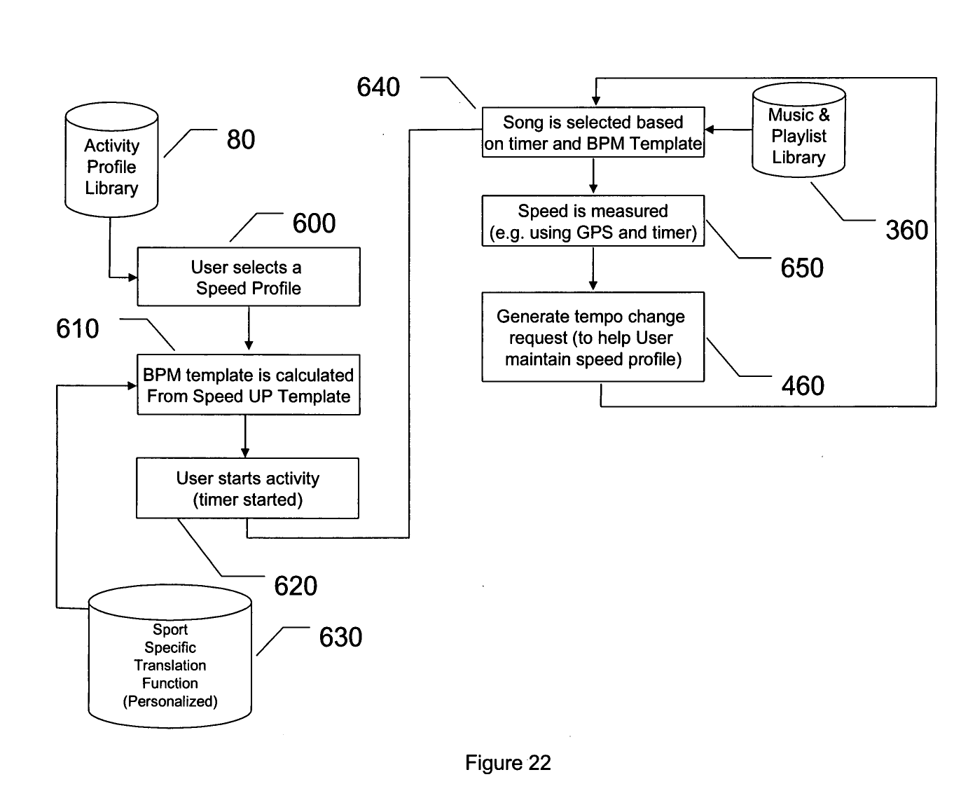

The sports specific translation function (personalized) 630 in FIG. 22 stores a calculated stride length for a user, based on prior runs the user has engaged in. It is a simple calculation, based on the BPM of the music and the actual distance covered. An illustrative embodiment would keep a simple average stride length for each unique user. Absent any past activity data for a user, the initial stride length would be approximated through a table look up based on the user's height, weight, age, etc.

The second example is of a heart rate UP template for running. In this example, we illustrate a different approach to translating the heart rate UP template to a BPM template. In this method, research is performed prior to the manufacture of the device that relates heart rate templates to BPM templates. Heart rate templates, categorized by gender, age, weight, height, activity type (e.g. running), etc., and associated BPM templates are stored as pairs in the sports specific translation function (personalized) 630. A user selects a heart rate UP template and function 630 looks up and returns the associated BPM template, which is used to set the tempo of the music. It is recognized that other factors may be useful to maintain (such as duration) for organizing the pairs of templates. Alternatively, duration can be handled by scaling the templates in the time dimension.

Each time a user executes a heart rate UP profile, representative parameters, such as maximum heart rate for a particular tempo, are stored. This information is used to personalize the translation from the heart rate UP template to BPM template on subsequent executions of the profile.

It should be noted that the conversion of a heart rate UP template into a BPM template is only one means of selecting music, based on the tempo, to guide a user to an inputted target activity goal. There are numerous other means including rule-based approaches and other computer algorithms such as neural nets and Baysian nets.

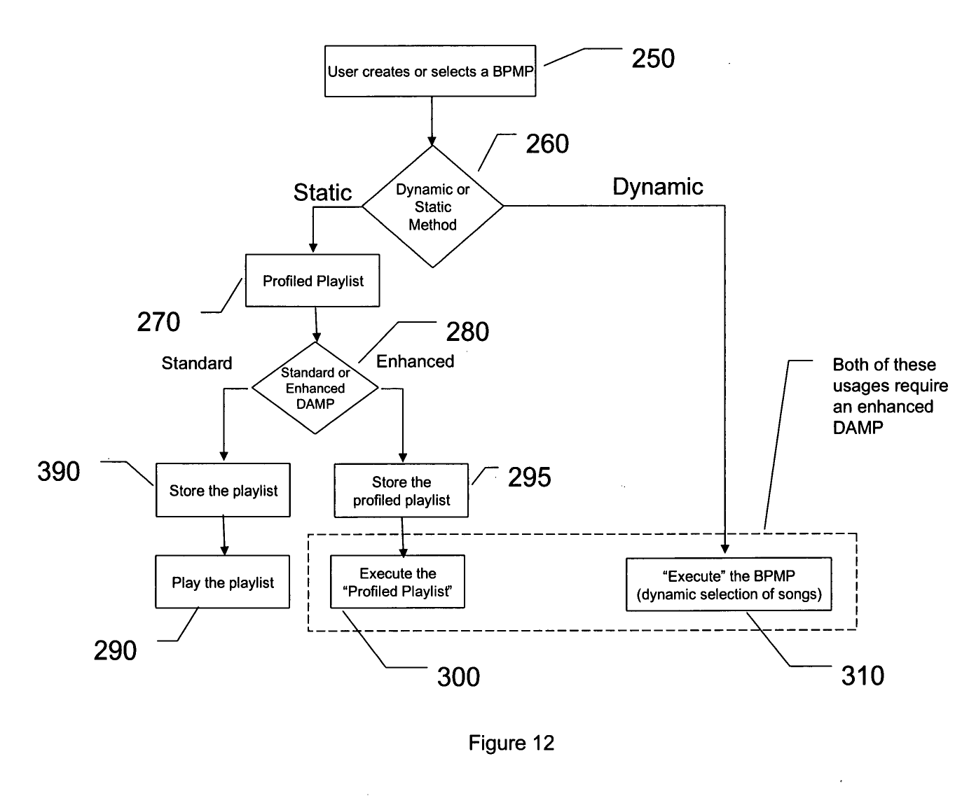

As shown in FIG. 12, once a BPM template 84 and other parameters of a BPMP are created by the user or otherwise provided to the user by other third party creators in step 250, the user may either compile a playlist of songs to correspond to the activity that is associated with the BPMP, or elect for the digital controller 30 to dynamically assign songs to correspond to the activity (step 260). If the user compiles a playlist (static method), the playlist is referred to as a Profiled Playlist 270 because it is a playlist of songs wherein the songs remain associated with the originating Profile (the BPM template 84 and the user selected parameters). The process of generating a Profiled Playlist from a template is coordinated by the editor 10 and various software modules. Once generated, the Profiled Playlist 270 may be stored. The user may save it as a Profiled Playlist, as in step 295, or store it as a standard playlist, as in step 390. The Profiled Playlist may be played on an Enhanced DAMP, whereas the standard playlist may be played on a standard DAMP.

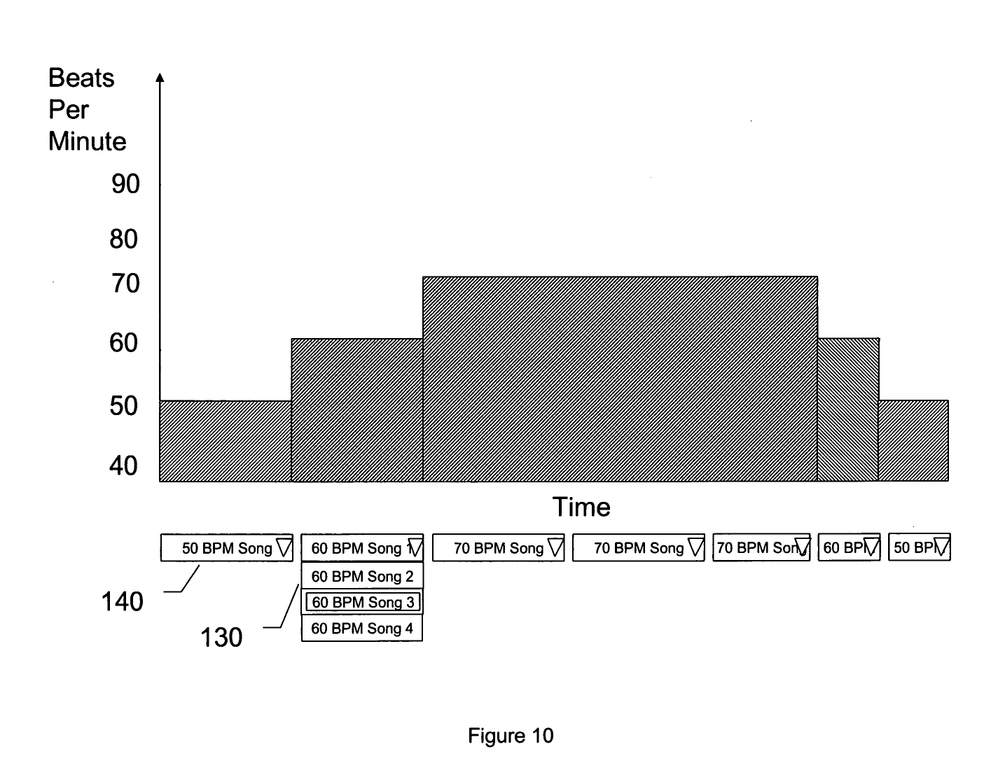

As shown in FIG. 10, songs are selected by the editor 10 to match the predetermined BPM of the BPM template based on the song's BPM. At stage 140, the predetermined BPM is 50 and therefore, a song having 50 BPM is selected to match the predetermined BPM. At stage 130, the predetermined BPM is 60, and a variety of songs having 60 BPM are available for selection to match the predetermined BPM. In this case, song 3 is selected by a user via editor 10. The user may optionally elect to have the editor 10 dynamically assign the songs. All song selections are made by the editor 10 within the song selection tolerance level 147 (FIG. 11), as specified in the parameters.

The generated Profiled Playlist 270 is stored in step 295 and later executed in step 300. A digital controller 30 can be used to execute the Profiled Playlist 270 in conjunction with the specific activity to which the songs have been tailored. The use of a Profiled Playlist 270 is a static method for tailoring music to an activity.

On the other hand, the automatic assignment or selection of songs by the digital controller 30 during execution in step 310, without a pre-set playlist, is a dynamic method for tailoring music to an activity. In the dynamic method, songs are selected on the fly. The dynamic method does not require a profiled playlist, or any other type of playlist. The dynamic method only requires an Activity Profile, such as a BPMP, for selecting music. A combination of software and hardware which is referred to as the Run Time Control Logic 45 (RTCL) (see FIG. 2) facilitates the selection of suitable songs on the fly (among other things). The dynamic method will be discussed in more detail later.

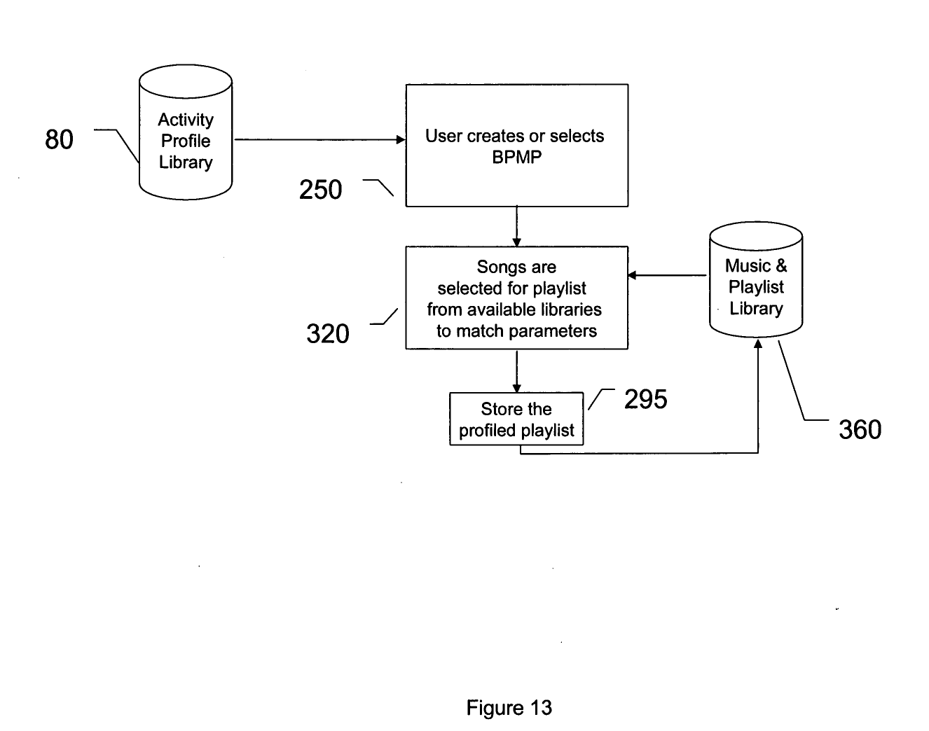

FIG. 13 shows an example of the process of creating a Profiled Playlist 270 statically. Based on the parameters in the profile, the editor 10 calls upon the RTCL 45 to select songs from the Music and Playlist Library 360, or some other music source, to match the parameters (step 320). Once the Profiled Playlist 270 is compiled from the selected songs, it is stored for future use in the Music and Playlist Library 360, in step 295.

Music criteria may be used as a parameter for assisting in the generation of a profiled playlist in the following manner. In an illustrative embodiment, the Music and Playlist Library 360 is kept in a relational database and is accessible using standard SQL (structured query language) queries. Other types of database technologies such as XML can also be used. The Music and Playlist Library 360 relational database contains records of songs. The fields of the records will include a wide variety of information including the BPM of the song, the song title, artist, genre, album, user rating, etc. The editor 10 opens the music criteria parameters and is instructed to execute an SQL query on the music and playlist library 360, based on the criteria in the Music Criteria parameter 142. Thus, the editor 10 is able to select songs from the music and playlist library 360 based not only on the BPM of a song within a particular tolerance level, but also on other features of the songs which are detailed in the BPMP 90. In another embodiment, this is done using standard search and natural language query capabilities.

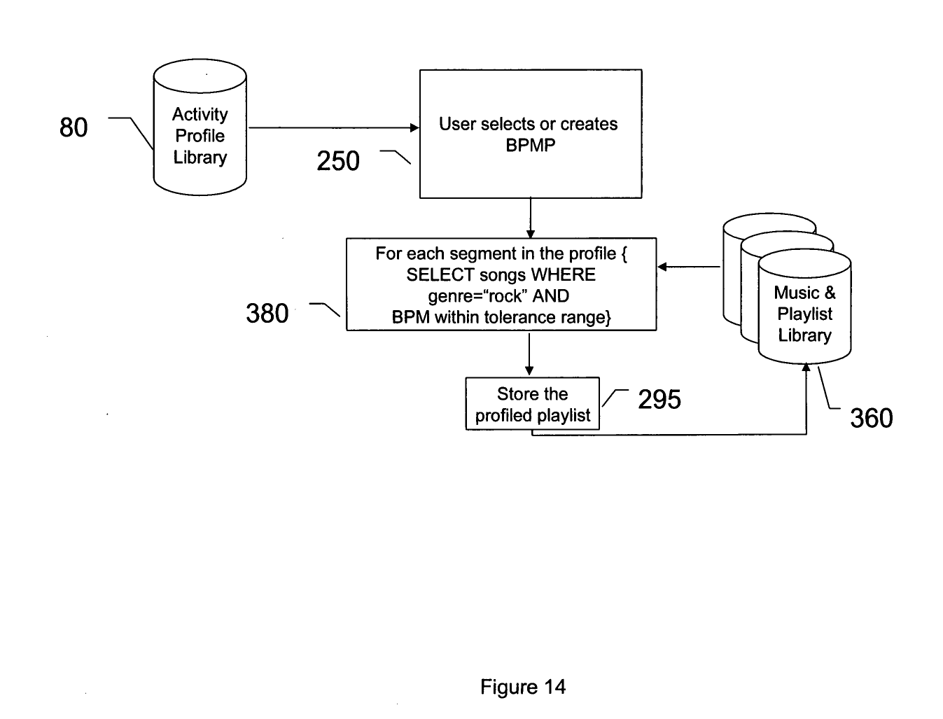

In one specific example, the user creates a BPMP with the editor 10 in which only top-rated classical music is chosen as the Music Criteria 142 parameter (FIG. 11) in addition to songs having a BPM matching the BPM template 84. In another example shown in FIG. 14, a playlist is created based on a match between the BPM of the music and the BPM of the BPM template 84, and is further limited to music that is of the “Rock” genre, which was specified as criteria in the BPMP 90 using Music Criteria 142 parameter. In FIG. 14, the user creates or selects a BPMP in step 250. In step 380, the editor 10 calls upon the RTCL 45 to conduct a query of the music SQL database for songs in which the genre is rock and the BPM value matches the BPM of the active time segment within the defined song selection tolerance level 141. Once a profiled playlist of the songs is compiled, it is stored in the Music and Playlist Library 360 in step 295.

The system can be used to create a playlist that has a musical theme, such as “riding”. The user specifies the theme in the Music Criteria 142 parameter which is used by the editor 10 to query the SQL database of the music library to identify music that relates to the theme. Once a subset of the library is identified as relating to the theme, it is mapped to the BPMP. The resulting Profiled Playlist 270 may be stored in the music and playlist library 360.

The following sections describe how Activity Profiles and Profiled Playlists may be used to manage the tempo of music to support a user in an activity. In its simplest application, a user may save a Profiled Playlist 270 as a standard playlist, and then engage it on a standard DAMP (step 290 in FIG. 12). In this scenario, a user would be performing their activity while listening to the songs in the playlist. The user would have no ability to interact with the playlist, other than what is available as standard DAMP controls, but they would be exercising to the music that was specifically selected for their activity.

An illustrative embodiment of this application could be implemented as an extension of the popular APPLE™ “iTunes” program (or any other such program) that manages a library of music. For instance, iTunes could be extended to include a set of features that (1) automatically calculates the BPM of every song in the library and (2) allows the user to create a playlist based on BPM. The process of creating a playlist based on BPM could be done in any manner. For example, the user could select an activity profile from a library of activity profiles or construct/modify an activity profile using editor 10. Based on the activity profile, a BPM template could then be generated. Then, based on the BPM template, songs could be automatically/randomly selected from the library that match the BPM template, or using an interface such as that shown in FIG. 10, the user could build a playlist of songs that match the BPM template and activity profile.

Of course, there are many variations on the implementation of this set of features, which could be added to any music library program. These features could be implemented on a PC or other digital device to construct the standard playlist, which is then used or downloaded. In this manner, the creation of playlists, with specific control of music tempo as it varies over time or distance, is enabled and can be used with any MP3 or DAMP player that supports playlists.

The more robust applications of the invention allow for user interaction. As such, when starting an activity, a user may either execute a Profiled Playlist or execute an AP dynamically. Either method will provide music that is tailored to support a user in adhering to an activity or goal. A Profiled Playlist is engaged by a user selecting a Profiled Playlist on an Enhanced DAMP. An AP is executed dynamically by a user selecting an AP on an Enhanced DAMP. The Profiled Playlist already has songs selected, whereas the Dynamic AP will have songs matched to the profile on the fly during the activity. In either case, the music is played via the Run Time Control Logic 45 and modifiable by editor 10 on the Enhanced DAMP.

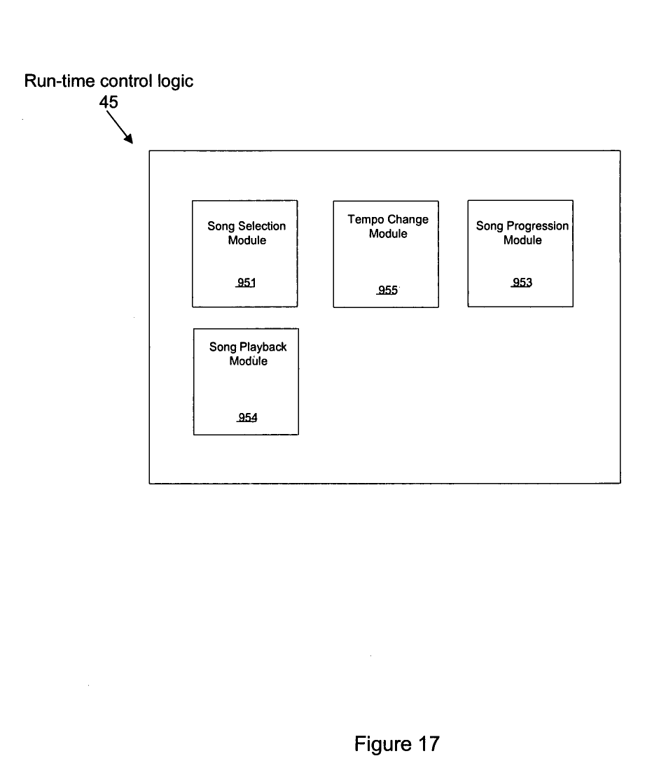

As shown in FIG. 17, the RTCL 45 has a variety of software modules: the song selection module 951 for selecting a song from the Music and Playlist Library 360 based on the parameters, a song progression module 953 which monitors the time that a song has played, a song playback module 954 for playing selected songs, and a tempo change module 955 which monitors whether a tempo change request has been made.

A user can have direct interaction with both a Profiled Playlist or a dynamically executed AP by operating the editor 10 through the Digital Controller 30. As described earlier, the Profiled Playlist 270 is a sequence of songs that is associated with a profile—either a BPMP or a UPP. Hence, executing a Profiled Playlist or an AP gives access to the parameters defined therein. As the user begins the activity, the RTCL 45 selects and plays songs based on the parameters in the associated profile.

It is generally known in the art to use a combination of hardware and software to determine the status of a particular feature and make modifications if the current status meets or does not meet a particular expectation or requirement. The hardware and software of the run-time control logic 45 perform the same type of function of determining the status of certain features like the progression of a song, or the BPM of an active time segment in an AP, or changing the tempo of a song based on the status information received. This complicated process is described in greater detail below.

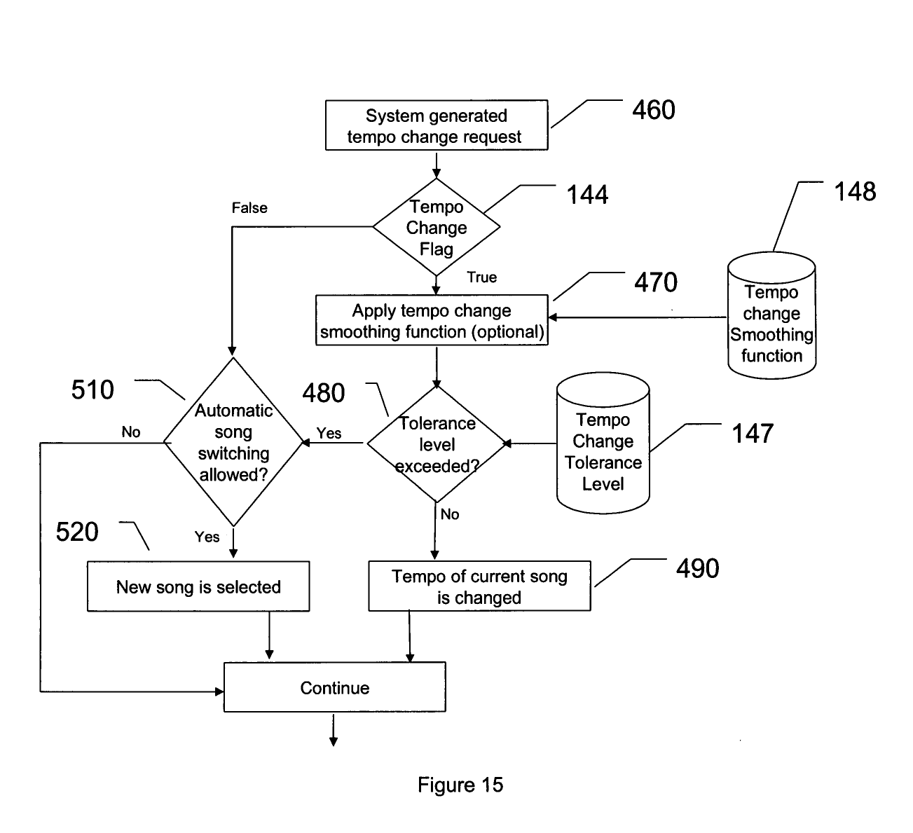

FIG. 15 depicts the logic involved in a system generated tempo change request 460. The tempo change flag 144 defines whether songs are to be played at their original tempo or at a tempo which exactly matches the BPM in the BPM Template. For example, if a user creates a BPM template 84 containing a constant 60 BPM and a song selection tolerance level 141 of +/−3 BPM, the editor 10 will compile a playlist of songs in which the songs match a BPM within the song selection tolerance level range. For example, the songs respectively may have a BPM of 63, 59, 57, 61 and 61. If the Tempo Change Flag 144 is enabled, the RTCL 45 will automatically alter the playback tempo of the five songs to maintain a constant 60 BPM, matching the BPM of the BPM template.

This alteration could potentially distort the selected songs in an unfavorable manner if the alteration is too great as a result of a very broad song selection tolerance level 141. Although a smaller song tolerance level would prevent such extreme distortion, it would also narrow or reduce the pool of songs that would be available for BPM matching. As described earlier, the tempo change tolerance level 147 defines a range of BPM modification that will be tolerated. Tempo change tolerance level 147 can be expressed as a percentage of the BPM, as an absolute BPM, or some other possibly non-linear function. The RTCL will look at the tempo change tolerance level 147 parameter when playing songs, and determine whether a tempo change is out of the tolerance level.

To illustrate, one active segment of a BPM Template may be assigned with 60 BPM. If the song selection tolerance level 141 is designated as +/−3 in the profile, one of the songs chosen may be 57 BPM. If the tempo change flag 144 is enabled (ie: tempo alteration is allowed), then the RTCL 45 would play this song at 60 BPM, not 57. This may obviously distort the song in an unfavorable manner. The RTCL 45 will check the tempo change tolerance level 147, and determine whether this change is allowed. If the tempo change tolerance level 147 parameter is set at +/−7 BPM, this change of 3 BPM would be tolerated.

If the requested tempo change complies with the tempo change tolerance level 147, the tempo of the song is changed. If the change does not comply with the tempo change tolerance level 147, and automatic song switching is allowed, the song selection module selects a new song which has a BPM that matches the requested tempo—step 510.

As an option, when a tempo change is requested, a tempo change smoothing function 148 can be applied. This parameter is selected when creating or editing an AP. The tempo change smoothing function 148 controls how changes of tempo are handled. Some examples of these smoothing functions are:

1. Rule based smoothing. An example rule is “the tempo can not change more than 2 BPM over a 10 second interval”. If the BPMP calls for a shift from 50 BPM to 60 BPM, the enhanced DAMP will increase the tempo of the music in 10 second intervals at 50, 52, 54, 56, 58, 60 BPM.

2. Linear smoothing: If the BPMP calls for a BPM of 50 at time t1, and 60 at time t2, the smoothing function will linearly interpolate the BPM between t1 and t2 and adjust the playback of the music to match the interpolated BPM.

3. Non-linear smoothing. As in example 2, the BPMP calls for a BPM of 50 at time t1, and 60 at time t2. In this case, we apply a non-linear smoothing function. An example function that is second degree differentiable is:
BPM=BPM1+(BPM2−BPM1)*cos [((t−t1)/(t2−t1))*P+P]
for t1<t<t2,

and

where BPM1 is the starting BPM (50 in this case) and BPM2 the ending BPM (60 in this case).

It is well known in the art that DAMPs are capable of altering the tempo of music without changing the pitch or timbre.

One skilled in the art will understand that there are endless variations of computerized means containing software and hardware which can be combined in different ways to accomplish the described functions. This is only one example of a configuration that can be used to carry out the functions described. The present invention is not limited in any way to this configuration.

The use of the RTCL 45 together with a CMP 88 is described as follows. When executing a CMP 88, a pedometer and timer may be used to measure cadence or rhythm. RTCL 45 software is used to analyze the pedometer and timer output to calculate the cadence of the user. Alternatively, an accelerometer and timer may be connected to the Digital Controller 30. The output of these is used by the RTCL 45, and a Fourier transform is performed to place the pedometer signal in the frequency domain so that the frequency can be analyzed. As part of the analysis, a search is performed to find the dominant frequency in the signal. The dominant frequency, or a harmonic thereof, is used to determine a cadence. The RTCL 45 selects songs with BPMs that match the derived cadence frequency or harmonic.

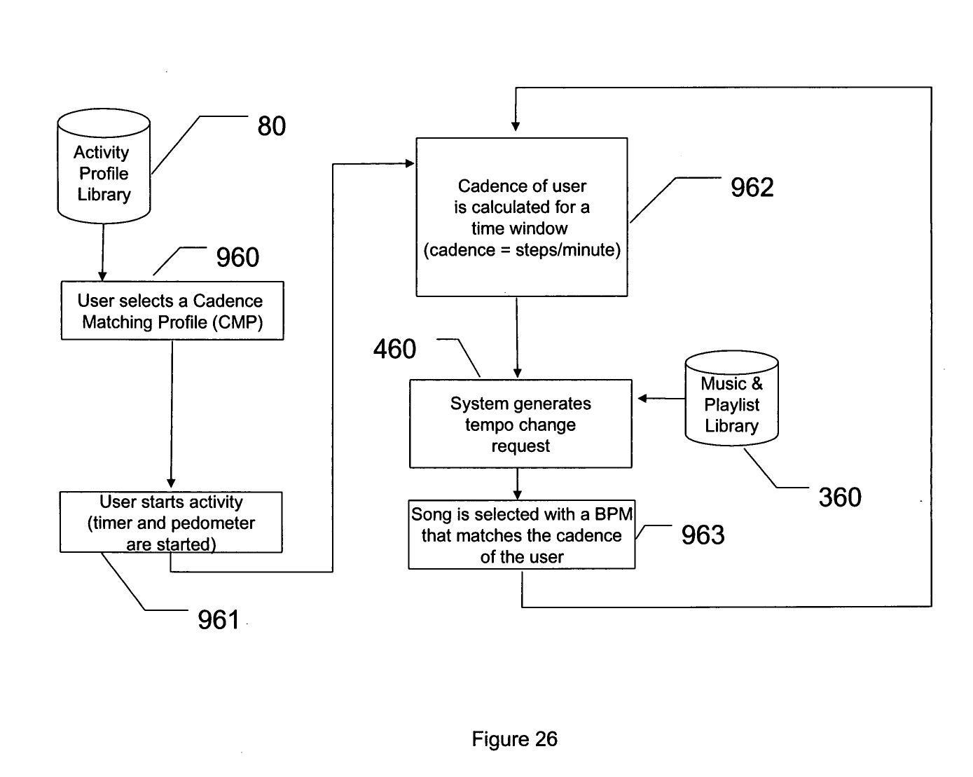

As shown in FIG. 26, a user selects a CMP in step 960 from the AP Library 80. In step 961, the user begins the activity, and the timer and pedometer (or accelerometer) are started. In step 962, the user's cadence is calculated. If the cadence varies from the BPM of the current song, then the RTCL 45 generates a tempo change request 460. This will result in either the tempo of the current song being modified, or a new song being selected. This matching continues until the user ends their activity.

The use of the RTCL 45 together with a BPMP 90 is as follows. The profile may be executed dynamically or statically. In the static method, a user selects the Profiled Playlist corresponding to the profile. When executed, the RTCL 45 will play the songs in the Profiled Playlist. In the dynamic method, the songs are selected by the RTCL 45 on the fly. The user may operate the editor 10 through the Digital Controller 30 to change parameters or create new parameters corresponding to the base Profile. The response of the RTCL 45 to any user input via the Digital Controller 30 is the same whether engaged in a Profiled Playlist or a BPMP. Examples of user input and how the RTCL 45 responds is detailed below.

The user may operate the editor 10 to change the BPM in a particular time segment of the BPM Template, or he may revise the Tolerance Level parameters. The BPMP and the Profiled Playlist are both updated in accordance with the changes to the parameters. The changes can optionally be saved. If saved, the user may overwrite the current BPMP or create a new instance of a BPMP.

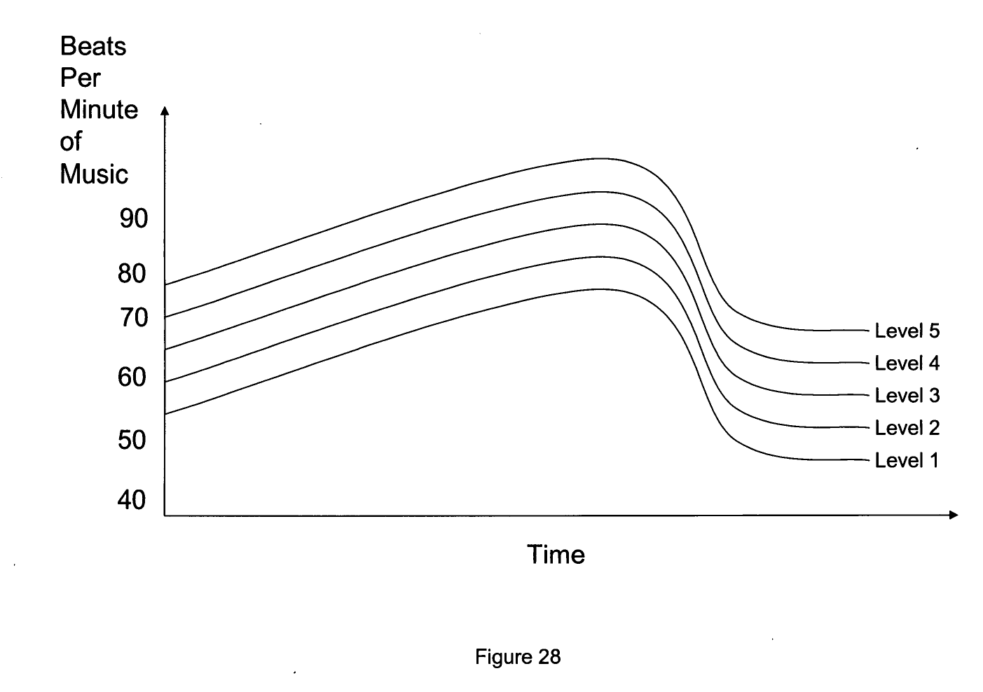

A user may want to dynamically (i.e., while exercising) boost or dampen the BPM values. For example, a “hill climbing” BPMP might contain beats-per-minute values that range from 60-80. The user could increase the intensity of the workout while exercising so that the basic shape of the hill climbing BPMP is retained, but the values are uniformly boosted to range from 65 to 85. Both linear and non-linear boosting and damping functions can be applied. One possible embodiment of this feature is for the user to specify a workout “level” or “intensity level” where the device has a set number of preprogrammed profiles as shown in FIG. 28. The user simply changes the level as she is working out.

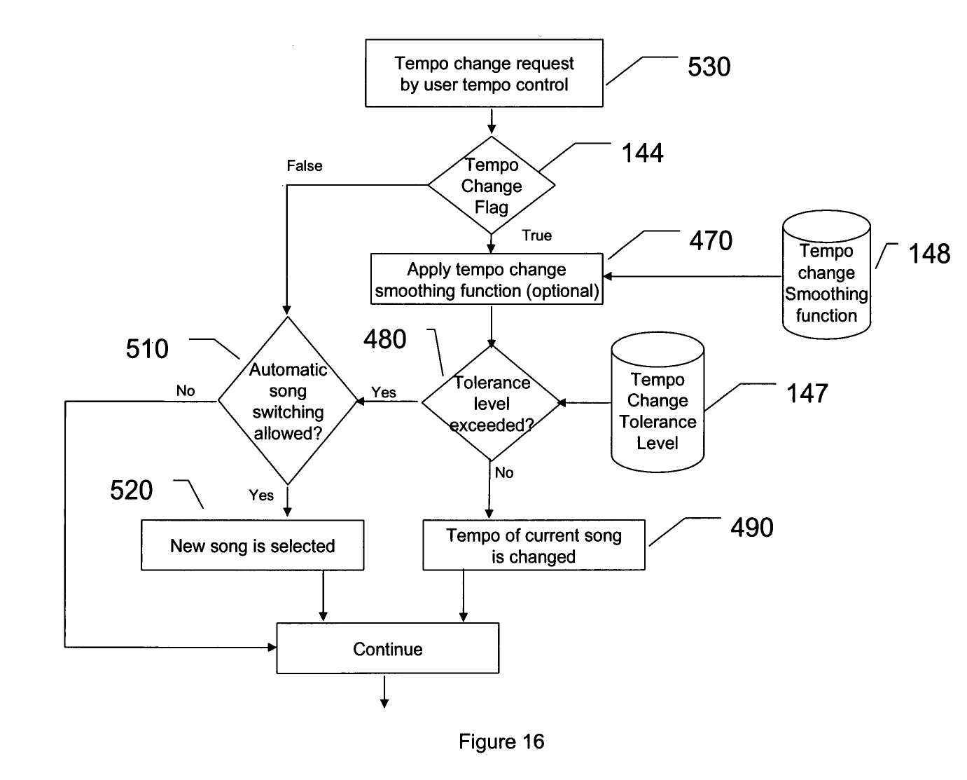

As shown in FIG. 16, when the user inputs the tempo change request via the user tempo control 150 in step 530, the RTCL 45 performs the same steps as in FIG. 15.

The BPMP may also be changed during song playback by changing the BPM for a fixed time duration, changing the BPM for the time segment corresponding to the remainder of the current song, or changing the BPM for the time segments corresponding to the remainder of the profile. The action of the RTCL 45 is as described earlier.

The user may desire to lengthen or shorten a workout while exercising. A BPMP may be changed during song playback by changing the duration of the template. For example, assume a user has selected to enlist a BPMP that is 30 minutes in duration. The user may change the duration of this BPMP to 40 minutes. Assume the original BPMP was 3 minutes for warm up, 24 minutes of full exertion and 3 minutes for cool down. If the segments of the BPMP were defined as percentages, the BPMP would be modified so that the overall shape is maintained. This would result in a 4 minute warm up, 32 minutes of full exertion, and a 4 minute cool down.

Alternatively, if the segments of the BPM Template were defined as a combination of fixed and automatically adjustable time lengths (for example, a runner may desire a 3 minute warm up and cool down, regardless of the length of the BPM Template), the first and last segments are “fixed” in duration. Changing the overall duration of the BPM Template results in the middle segment, the “automatically adjustable” segment, to be shortened or lengthened in accordance with the fixed segments and overall length of the BPM Template. The result, for this example, is a BPM Template that has 3 minutes each for warm up and cool down, and 34 minutes of full exertion. The RTCL 45 will select additional songs to match this modified BPMP. Again, when the workout is completed, the invention will query the user as to whether they would like to keep the modified BPMP and/or Profiled Playlist.

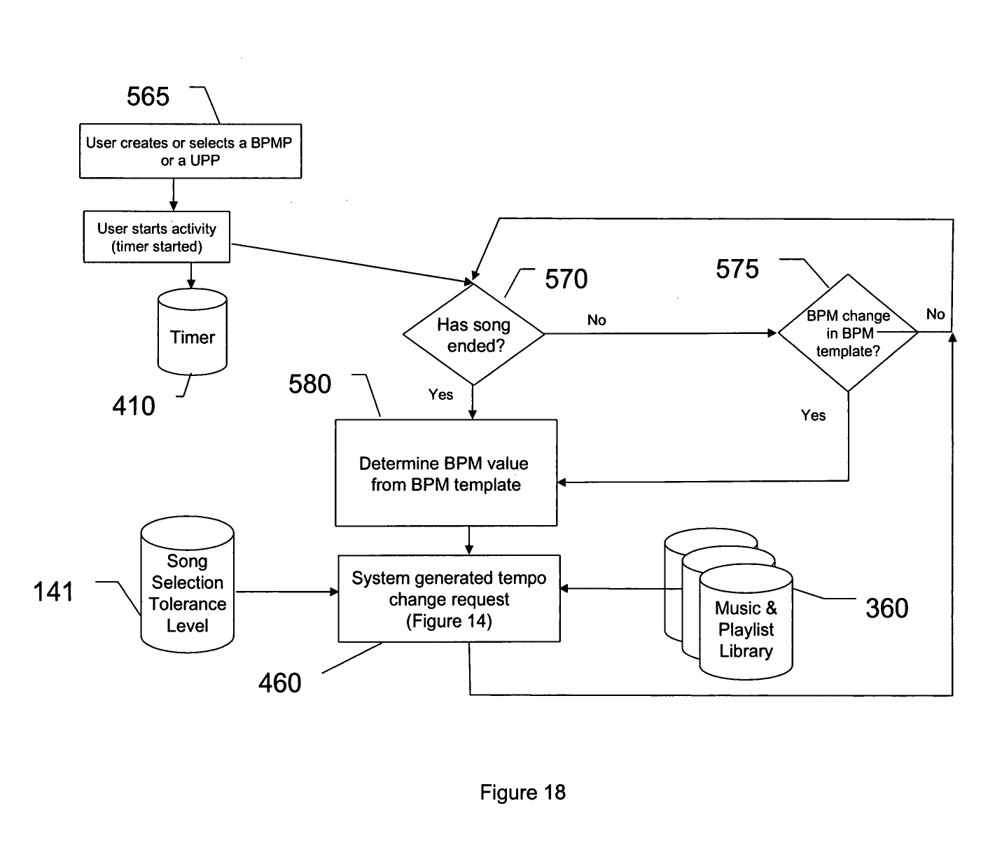

The operation of the dynamic method is illustrated in more detail in one embodiment shown in FIG. 18. Prior to starting an exercise routine, the user creates or selects a BPMP in step 565, which becomes an active BPMP once it is selected. At the start of the exercise routine, timer 410 is started. As the timer 410 continues to run, the RTCL 45 monitors at least three events:

1) It checks the BPM template to see if a tempo change is required, i.e., based on how much time has elapsed since the exercise routine started (which is determined by timer 410), the BPM Template is checked in step 575 to see if there is a new BPM value as a result of the active time segment changing. For example, referring back to FIG. 9, the time segments during the full exertion phase 110 have an assigned BPM that is much higher than the time segments during the warmup phase 100. Thus, when the active time segment changes from the warmup phase 100 to the full exertion phase 110, there is a new BPM value. Therefore, a tempo change is required in the current song so that the BPM of the music matches the new BPM of the new active time segment in the full exertion phase. The BPM change must comply with a tempo change tolerance level if such tolerance level is provided in the profile.

2) The song progression module 953 (FIG. 17) checks to see if a song has ended and a new song needs to be selected in step 570. This is accomplished by regularly monitoring the progression of the song. Songs can be dynamically mixed based on the information that the song progression module provides. For example, a BPM Template calls for starting out a workout at 60 BPM for 3 minutes and then increasing the intensity to 70 BPM. If the first song selected is at 60 BPM, but lasts for 4 minutes, the system can “fade out” the song after 3 minutes by monitoring the song's progression and “fade in” a 70 BPM song. The song progression module informs the song selection module that the song has played for three minutes and that a new song needs to be selected. The song selection module then selects a song that has a BPM of 70 to match the BPM of the next phase of the activity. This is just one example of how one song can segue into another.

3) The tempo change module 955 checks to see if the user has requested a tempo change via user tempo control 150.

If the RTCL 45 determines that a new BPM is required, based on the current time from the timer and the BPM Template, the RTCL 45 determines the new BPM in step 580. The tempo of the song currently being played can be adjusted, as described above in 1, or a new song can be selected. The song selection module 951 selects a new song with a BPM that matches the BPM of the active time segment, within the song selection tolerance levels.

If the RTCL 45 determines that a song has ended, then it determines the BPM of the active time segment and chooses a new song with a BPM that matches the BPM of the active time segment and is within the song selection tolerance levels.

Parameters can also be modified directly during song playback using editor 10 through the Digital Controller 30 to dynamically change song selection. That is, when a parameter is changed, the song selection module 951 will automatically refer to the changed AP for selecting songs after the change is made. The user may also use editor 10 to change the current song if desired.

The RTCL 45 together with a UPP 900 will help a user adhere to a desired goal in an activity. As in a BPMP, a user may execute a Profiled Playlist that was derived from a UPP 900, or may execute a UPP 900 dynamically, without a playlist assigned. The actions of the RTCL 45 are the same here as for the use of a BPMP, as described above. However, a UPP has the additional task of helping a user adhere to a UP Template 911. Depending on the type of activity involved, a specific Real Time Monitoring Device 60 (FIG. 2), which measures an activity value, is connected to the Digital Controller 30. The activity value may for example comprise a heart rate, blood pressure, respiration, speed, position, distance, cycles per minute, strokes per minute, count and time, etc. FIG. 22 shows an illustrative embodiment of the invention in which a UPP 900 is used to assist a user in adhering to a speed template. In step 600, the user selects a speed UPP 900 from the Activity profile library 80. In step 610, the UP template is transformed into a BPM template. In step 620, a timer is started when the user activity begins. In step 640, a song is selected dynamically (via a song selection module 951) to match the BPM for the BPM Template. A RTCL 45 module monitors the progression of the activity to determine which time segment of the time period is active and to determine the beats per minute value of an activity at the active time segment. A song progression module 953 of the RTCL 45 monitors the time that a song has played in order to determine when a new song is needed.

During the activity, speed is measured via a GPS subsystem 220 in step 650. If the speed of the user does not match the desired speed as laid out in the UP Template, the RTCL 45 generates a tempo change request, step 460. If the measured speed is less than the desired speed value in the template, then the user has fallen behind. If the measured speed is greater than the desired speed, then the user is ahead. If the user has fallen behind, the tempo change request will cause an increase in the tempo of the music until the measured speed becomes equal to the desired speed of the active time segment. If the tempo change exceeds a tempo change tolerance level, a song selection module will select a new song with an increased tempo. Thus, in step 460, the RTCL 45 works automatically to maintain the UPP 900. The process is repeated beginning at step 640 until the end of the template.

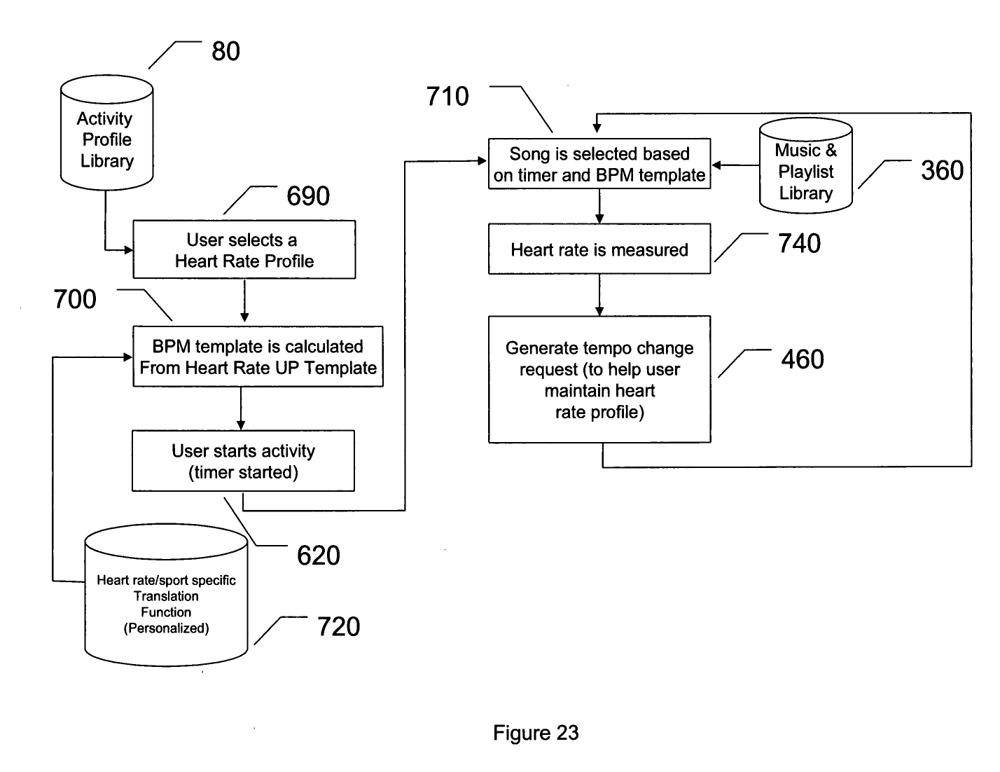

FIG. 23 shows another illustrative embodiment of the invention in which a Heart Rate UPP 900 is used to assist a user in maintaining a Heart Rate Template. In step 690, the user selects a heart rate profile from the Activity Profile Library 80. In step 700, the UP Template is transformed into a BPM Template. As an example, the UP Template may have a time segment at 140 heart beats per minute, which is translated into a 90 BPM song for the corresponding BPM Template time segment. In step 620, a timer is started when the user activity begins. In step 710, a song is selected dynamically to match the BPM for the BPM Template. As in the speed example above, the RTCL 45 monitors the progression of the activity to determine which time segment of the time period is active and to determine the beats per minute value of an activity at the active time segment. A song progression module monitors the time that a song has played in order to determine when a new song is needed.

During the activity, heart rate is measured via a heart rate monitor 230 in step 740. The measured heart rate is compared to the desired heart rate as specified in the active time segment of the UP Template. If the measured heart rate value does not match the desired BPM value assigned to the active time segment, then the user is not maintaining the heart rate of the UP Template, and the RTCL 45 submits a tempo change request (step 460). If the measured heart rate value is less than the desired value, then the user has fallen behind. If the measured heart rate value is greater than the desired value, then the user is ahead. If the user has fallen behind, the tempo change request will cause an increase in the tempo of the music until the measured heart rate becomes equal to the desired heart rate of the active time segment. If a tempo change exceeds a tempo change tolerance level, the song selection module 951 will select a new song with an increased tempo, until the measured heart rate becomes equal to the desired rate in the active time segment. Thus, in step 460, the RTCL 45 works automatically to help the user adhere to the UPP 900. The process is repeated beginning at step 710 until the end of the template.

As shown in FIG. 21, some examples of UP Templates 911 are heart rate templates 901, blood pressure templates 902, respiration templates 903, speed templates 904, position templates 905, distance template 906, cycles per minute template 907 used by a bicyclist for example, and strokes per minute template 908 used by a swimmer for example.

The invention also allows for personal attribute information 145 to be saved. This information is used by both the editor 10 and the RTCL 45. The editor 10 may use the personal attribute information 145 to help a user select an AP based on personal information such as age, gender, weight, or height. The RTCL 45 may use the personal attribute information 145 when engaged in a UPP, so that personal information may be used in converting a UP Template into a BPM Template. Adaptive learning algorithms 146 are another feature of the invention, and are used to select songs based on the recorded personal attributes of the user.

An example of the use of the personal attribute parameter 145 for creating a Profiled Playlist is described as follows. Adaptive learning algorithms programmed into the editor 10, or executed separately by the editor 10 are used to select songs based on recorded personal attributes of the user. For example, assume an individual selects a specific heart rate profile for a run. The editor 10 calculates a likely BPM profile and selects music to match the BPM Template. The user then begins the activity using the playlist. The user's heart rate is recorded and compared to the original, desired profile. If the user is in great (or poor) shape, it is likely the actual heart rate will not be an appropriate match for the desired profile. The editor 10 will store the individual's data in Personal Attributes 145 and recalculate an appropriate BPM Template for the next time the same activity is initiated. The recalculation may be based on an algorithm. An appropriate BPMP Template may also be reconstructed from a chart of predefined data based on research in which a variety of appropriate BPM have already been determined for different heart rate conditions.

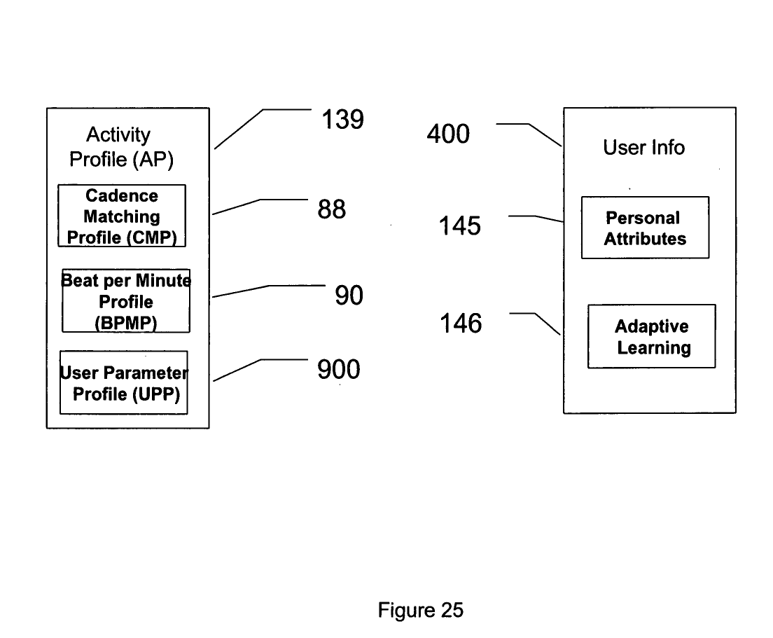

APs 139 (FIG. 25) may be based on specific sports (running, swimming, cycling, etc.), since sports have unique characteristics such as cadences. Thus, a manufacturer can create APs for various sports which can be made available to a user of the digital controller 30. Standard athletic event profiles can be sold such as “5K run”, “marathon”, “triathlon”, “powder skiing”, “ice skating”, “walking”, etc. The user can choose a profile type (e.g., marathon) and execute an appropriate AP on the digital controller 30.

The invention allows for great flexibility in managing the tempo of music for various activities. The invention is designed such that a user can ‘mix and match’ templates with other profile parameters in order to generate a multitude of diverse activity profiles.

It should be appreciated that the teachings of the present invention could be offered as a business method on a subscription or fee basis. For example, a computer system 11 comprising song selection system 25 could be created, maintained and/or deployed by a service provider that offers the functions described herein for customers. That is, a service provider could offer to provide a song database 36, some or all of a song selection system 25, and activities programs 40 as described above.

In addition, although the embodiments described herein relates generally to the playback of audio information, other types of media data, such as video data, could likewise be played back for the user.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for choosing songs for playback during an activity based on an activity goal for a user, comprising:
a system for defining the activity goal for the user, wherein the activity goal comprises an activity value that varies;
a database of songs;
a system for selecting songs from the database of songs and causing the selected songs to be played as the user performs the activity, wherein each selected song includes a tempo that guides the user to maintain an associated activity value defined in the inputted activity goal; and
a feedback system that obtains feedback regarding the activity being performed by the user and determines if the user is on target to meet the inputted activity goal, wherein the feedback system automatically makes adjustments to the tempo during song playback if the user is not on target to meet the inputted activity goal.

2. The system of claim 1, wherein the activity value comprises a characteristic selected from the group consisting of: heart rate, blood pressure, respiration, speed, position, distance, cycles per minute, strokes per minute, count and time.

3. The system of claim 1, wherein the tempo comprises a value in beats per minute.

4. The system of claim 3, wherein the database of songs comprises a list of songs and associated beats per minute for each song.

5. The system of claim 1, further comprising a system for smoothing transitions between songs of different tempos.

6. The system of claim 1, wherein the system that automatically makes adjustments to the tempo during song playback includes:
a system for adjusting the tempo of a current song; and
a system for changing the current song to a new song.

7. The system of claim 1, wherein the tempo of each selected song is selected to match a harmonic of a target cadence rate required for the user to achieve an associated activity value.

8. The system of claim 1, further comprising an interface that includes a song display and playback controls.

9. The system of claim 8, wherein the playback controls include a control for allowing the user to adjust a parameter selected from the group consisting of: a song selection tolerance level, a music criteria, a music source, a tempo change flag, a tempo change tolerance level, a tempo change smoothing parameter, and an automatic song switching flag.

10. The system of claim 8, wherein the playback controls include a control for allowing the user to adjust the activity value in real time during song playback.

11. The system of claim 8, wherein the playback controls include a control for allowing the user to adjust the tempo in real time during song playback.

12. The system of claim 1, wherein the system for selecting songs includes a tolerance level that defines a range of tempos that result in a match.

13. The system of claim 1, wherein the system for selecting songs includes a selection criteria that refines song selection, wherein the selection criteria is selected from the group consisting of: title, artist, genre, theme, user rating, category, album, bit rate, comment, composer, date added, date modified, description, disc number, episode number, equalizer, grouping, kind, last played, my rating, play count, sample rate, season, show, size, time, track number, and year.

14. The system of claim 1, wherein the system for defining the activity goal comprises a user parameter (UP) template that defines how the activity value varies.

15. The system of claim 14, comprising a further system for converting the UP template into a beats per minute template that includes a set of tempo values that vary.

16. The system of claim 14, wherein the activity value varies over one of time and distance.

17. The system of claim 14, further comprising a system for saving a playlist that includes songs played during the performance of the activity.

18. A method for choosing songs for playback during an activity based on an activity goal implemented for a user, comprising:
defining the activity goal for the user, wherein the activity goal comprises an activity value that varies;
providing access to a database of songs;
selecting songs from the database of songs and causing the selected songs to be played as the user performs the activity, wherein each selected song includes a tempo that guides the user to maintain an associated activity value defined in the inputted activity goal;
obtaining feedback regarding the activity being performed by the user and determining if the user is on target to meet the inputted activity goal; and
automatically adjusting the tempo during song playback if the user is not on target to meet the inputted activity goal.

19. The method of claim 18, wherein the activity value comprises a characteristic selected from the group consisting of: heart rate, blood pressure, respiration, speed, position, distance, cycles per minute, strokes per minute, count and time.

20. The method of claim 18, wherein the tempo comprises a value in beats per minute.

21. The method of claim 20, wherein the database of songs comprises a list of songs and associated beats per minute for each song.

22. The method of claim 18, further comprising the step of smoothing transitions between songs of different tempos.

23. The method of claim 18, wherein the step of automatically adjusting the tempo during song playback includes either adjusting the tempo of a current song or changing the current song to a new song.

24. The method of claim 18, wherein the tempo of each selected song is selected to match a harmonic of a target cadence rate required for the user to achieve an associated activity value.

25. The method of claim 18, further comprising the step of providing an interface that includes a song display and playback controls.

26. The method of claim 25, wherein the playback controls include a control for allowing the user to adjust a parameter selected from the group consisting of: a song selection tolerance level, a music criteria, a music source, a tempo change flag, a tempo change tolerance level, a tempo change smoothing parameter, and an automatic song switching flag.

27. The method of claim 25, wherein the playback controls include a control for allowing the user to adjust the activity value in real time during song playback.

28. The method of claim 25, wherein the playback controls include a control for allowing the user to adjust the tempo in real time during song playback.

29. The method of claim 18, wherein the step of selecting songs includes a selection criteria that refines song selection, wherein the selection criteria is selected from the group consisting of: title, artist, genre, theme, user rating, category, album, bit rate, comment, composer, date added, date modified, description, disc number, episode number, equalizer, grouping, kind, last played, my rating, play count, sample rate, season, show, size, time, track number, and year.

30. The method of claim 18, comprising a further step for converting the activity value that varies into a set of tempo values.

31. The method of claim 18, wherein the activity value varies over one of time and distance.

32. The method of claim 18, comprising the further step of saving a playlist of songs that include songs played during the performance of the activity by the user.

33. A computer program product stored on a computer readable medium for choosing songs for playback during an activity based on an activity goal implemented for a user, comprising:
program code configured for defining the activity goal for the user, wherein the activity goal comprises an activity value that varies;
program code configured for providing access to a database of songs;
program code configured for selecting songs from the database of songs and causing the selected songs to be played as the user performs the activity, wherein each selected song includes a tempo that guides the user to maintain an associated activity value defined in the inputted activity goal;
program code configured for obtaining feedback regarding the activity being performed by the user and determining if the user is on target to meet the inputted activity goal; and
program code configured for automatically adjusting the tempo during song playback if the user is not on target to meet the inputted activity goal.

34. The program product of claim 33, wherein each activity value comprises a characteristic selected from the group consisting of: heart rate, blood pressure, respiration, speed, position, distance, cycles per minute, strokes per minute, count and time.

35. The program product of claim 33, wherein the tempo comprises a value in beats per minute.

36. The program product of claim 35, wherein the database of songs comprises a list of songs and associated beats per minute for each song.

37. The program product of claim 33, further comprising program code configured for smoothing transitions between songs of different tempos.

38. The program product of claim 33, wherein the program code configured for automatically adjusting the tempo during song playback includes code for either adjusting the tempo of a current song or changing the current song to a new song.

39. The program product of claim 33, wherein the tempo of each selected song is selected to match a harmonic of a target cadence rate required for the user to achieve an associated activity value.

40. The program product of claim 33, further comprising program code configured for providing an interface that includes a song display and playback controls.

41. The program product of claim 40, wherein the playback controls include a control for allowing the user to adjust a parameter selected from the group consisting of: a song selection tolerance level, a music criteria, a music source, a tempo change flag, a tempo change tolerance level, a tempo change smoothing parameter, and an automatic song switching flag.

42. The program product of claim 40, wherein the playback controls include a control for allowing the user to adjust the activity value in real time during song playback.

43. The program product of claim 40, wherein the playback controls include a control for allowing the user to adjust the tempo in real time during song playback.

44. The program product of claim 33, wherein the program code configured for selecting songs includes a selection criteria that refines song selection, wherein the selection criteria is selected from the group consisting of: title, artist, genre, theme, user rating, category, album, bit rate, comment, composer, date added, date modified, description, disc number, episode number, equalizer, grouping, kind, last played, my rating, play count, sample rate, season, show, size, time, track number, and year.

45. The program product of claim 33, further comprising program code configured for converting the activity value that varies into a set of tempo values.

46. The program product of claim 33, wherein the activity value varies over one of time and distance.

47. The program product of claim 33, further comprising program code configured for saving a playlist of songs that include songs played during the performance of the activity.

48. A method for deploying an application for choosing songs for playback during an activity based on an activity goal for a user, comprising:
providing a computer infrastructure being operable to:
define the activity goal for the user, wherein the activity goal comprises an activity value that varies;
access a database of songs;
select songs from the database of songs and cause the selected songs to be played as the user performs the activity, wherein each selected song includes a tempo that guides the user to maintain an associated activity value defined in the defined activity goal;
obtain feedback regarding the activity being performed by the user and determine if the user is on target to meet the inputted activity goal; and
automatically make adjustments to the tempo during song playback if the user is not on target to meet the inputted activity goal.
